(19) United States
(12) Patent Application Publication
(10) Pub. No.: US 2012/0081443 A1
(43) Pub. Date: Apr. 5, 2012

(54) INKJET PRINTING APPARATUS, INKJET PRINTING METHOD, IMAGE PROCESSOR AND IMAGE PROCESSING METHOD

(75) Inventors: Mitsuhiro Ono, Tokyo (JP); Ryosuke Iguchi, Kawasaki-shi (JP); Nobutaka Miyake, Yokohama-shi (JP); Tohru Ikeda, Yokohama-shi (JP); Akitoshi Yamada, Yokohama-shi (JP); Fumitaka Goto, Tokyo (JP); Hidetsugu Kagawa, Kawasaki-shi (JP); Tomokazu Ishikawa, Kawasaki-shi (JP); Junichi Nakagawa, Tokyo (JP); Senichi Saito, Kawasaki-shi (JP)

(73) Assignee: CANON KABUSHIKI KAISHA, Tokyo (JP)

(21) Appl. No.: 12/966,837

(22) Filed: Dec. 13, 2010

(30) Foreign Application Priority Data
Oct. 5, 2010 (JP) 2010-225751

(51) Int. Cl. B41J 2/205

(52) U.S. Cl. 347/15

(57) ABSTRACT

In the present invention, joint sections and non-joint sections are formed in nozzle arrays of a plurality of chips arranged in a print head. Correction values for correcting input image data are calculated for reducing color difference caused by variation in the ejection characteristics of the nozzles. In this calculation of correction values, first a first correction value corresponding to first nozzles that form a color measurement area is calculated based on the color measurement value obtained by measuring the color of a discrete color measurement area included in a patch formed by a nozzle array. Next, a second correction value for correcting input image data corresponding to second nozzles of the nozzle array is calculated based on the first correction value. Different complementary processing is used when calculating the second correction value corresponding to a non-joint section, and when calculating the second correction value corresponding to a joint section.

### BACKGROUND OF THE INVENTION

1. Field of the Invention

The present invention relates to an image processor and an image processing method. More particularly, the present invention relates to an image processor configured to decrease color difference caused by individual variations in the ejection characteristics of a plurality of nozzles that eject ink.

2. Description of the Related Art

In print heads used in inkjet printing apparatus, individual variations are sometimes exhibited in the ejection characteristics (i.e., the ejection volume and ejection direction, for example) of a plurality of nozzles, due to manufacturing errors and other factors. When such variation exists, printed images become more susceptible to density unevenness.

In the related art, one established process for decreasing such density unevenness involves using head shading technology such as that disclosed in Japanese Patent Laid-Open No. H10-013674 (1998). Head shading is a technology that corrects image data according to information regarding the ejection characteristics of individual nozzles. By means of such correction, the number of ink dots that are ultimately printed is increased or decreased for each nozzle, and the concentration (density) in the printed image can be made nearly uniform across the nozzles.

However, even when using the head shading technology described above, if a color is reproduced by overlapping two or more kinds of ink, a color difference occurs between the color of an area that is printed by nozzles having an ejection amount that differs from the standard amount and the color that is originally supposed to be printed.

By way of example, consider the case of printing a blue image using nozzles exhibiting standard ejection volumes for cyan ink, and greater-than-standard ejection volumes for magenta ink. In this case, the magenta ink with the greater-than-standard ejection volumes will form dots on the print medium that are larger than the cyan dots. If such a print head is corrected by means of head shading (i.e., an HS process), then magenta will be printed using fewer dots than the standard number of dots. In other words, the number of magenta dots will be less than the number of cyan dots. As a result, the blue image regions will contain a mixture of solid cyan dots of standard size, as well as overlapping dots wherein cyan dots are printed inside larger magenta dots. The coloring in such regions will be different from the coloring in a blue image printed using cyan dots and magenta dots of standard size and number. This occurs because the ratio of the print medium occupied by solid cyan, the ratio occupied by solid magenta, and the ratio occupied by blue resulting from overlapping cyan and magenta, all differ between the above two images.

Such variation in the surface area ratios occupied by respective colors occurs not only because of variation in ejection volume, but also because of variation in ejection direction. In other words, even if density unevenness in solid cyan images or solid magenta images is resolved by the head shading of the related art, the variation in ejection characteristics will still lead to color difference in blue images expressed by overlapping combinations of these colors. Furthermore, since the degree of color difference differs among the regions printed by nozzles with different ejection characteristics, different shades of color are perceived in individual regions that should have the same coloring, which is noticed as color unevenness.

### SUMMARY OF THE INVENT ION

Taking the aforementioned problem into consideration, the object of the present invention is to provide an inkjet printing apparatus, inkjet printing method, image processor and image processing method capable of reducing color difference that occurs when printing an image using a plurality kinds of ink that is caused by variation in ejection characteristics among a plurality of nozzles.

The first aspect of the present invention is an inkjet printing apparatus that prints an image on a printing medium by using a print head, wherein a plurality of nozzle arrays that eject ink of the same color are arranged such that there are joint sections in a direction that differs from the direction that the nozzles are arranged in the nozzle array, and ejecting ink from the nozzles according to input image data, the inkjet printing apparatus comprising: a correction value calculation unit configured to calculate correction values for each nozzle group obtained by dividing up the plurality of nozzles of the print heads in order to correct input image data by reducing color differences among the images printed by the different nozzle groups; wherein the correction value correction unit comprises: a first correction value calculation unit configured to calculate a first correction values as the correction value, the first correction value being used for correcting input image data corresponding to a first nozzle group that prints a patch, based on the color measurement value obtained by measuring a color of a patch printed by first nozzle group that is located at discrete positions among the nozzle groups; and a second calculation unit configured to calculate a second correction value as the correction value, the second correction value being used for correcting the input image data corresponding to a second nozzle group of the plurality of nozzle groups different from the first nozzle group by performing a complementary process based on the first correction value; wherein the second calculation unit performs a different complementary process for a second nozzle group that is located in the joint section and a second nozzle group that is located in a non-joint section that is different from the joint section.

With the present invention, it is possible to suppress degradation of an image that occurs due to variation in printing characteristics of each of a plurality of nozzles.

Further features of the present invention will become apparent from the following description of exemplary embodiments (with reference to the attached drawings).

### BRIEF DESCRIPTION OF THE DRAWINGS

FIG. 1 schematically illustrates an inkjet printing apparatus in accordance with an embodiment of the present invention;

FIG. 2 is a block diagram illustrating a printing system in accordance with an embodiment of the present invention;

FIGS. 3A and 3B are diagrams for explaining how color difference is produced when printing a blue image after having conducted head shading of the related art;

FIGS. 4A to 4D are block diagrams illustrating configurations of image processing operations executed by an inkjet printing apparatus to which the present invention may be applied;

FIGS. 5A and 5B are flowcharts for explaining, respectively, a process for generating the parameters of a table used by an MCS processor, and a process for executing image processing using parameters generated at the actual time of printing;

FIGS. 6A and 6B are diagrams for explaining the printed state of measurement images;

FIGS. 7A and 7B illustrate examples of images after an MCS process;

FIG. 8 illustrates lattice points taken at equally spaced coordinates in RGB space;

FIGS. 9A and 9B are flowcharts for illustrating a process of generating table parameters, and a MCS process that uses that table in a first variation of the embodiment;

FIGS. 10A and 10B are flowcharts for illustrating a process of generating table parameters, and a MCS process that uses that table in a second variation of the embodiment;

FIGS. 11A and 11B are drawings for explaining the printed state of a measurement image in a third variation of the embodiment;

FIG. 12 is a drawing for explaining the construction of a print head that is used in a second embodiment;

FIGS. 13A and 13B are drawings for illustrating the printing density of each nozzle before and after correction in a second embodiment; and

FIG. 14 is a flowchart for explaining a process of generating correction values in a second embodiment.

### DESCRIPTION OF THE EMBODIMENTS

Hereinafter, embodiments of the present invention will be described in detail and with reference to the drawings.

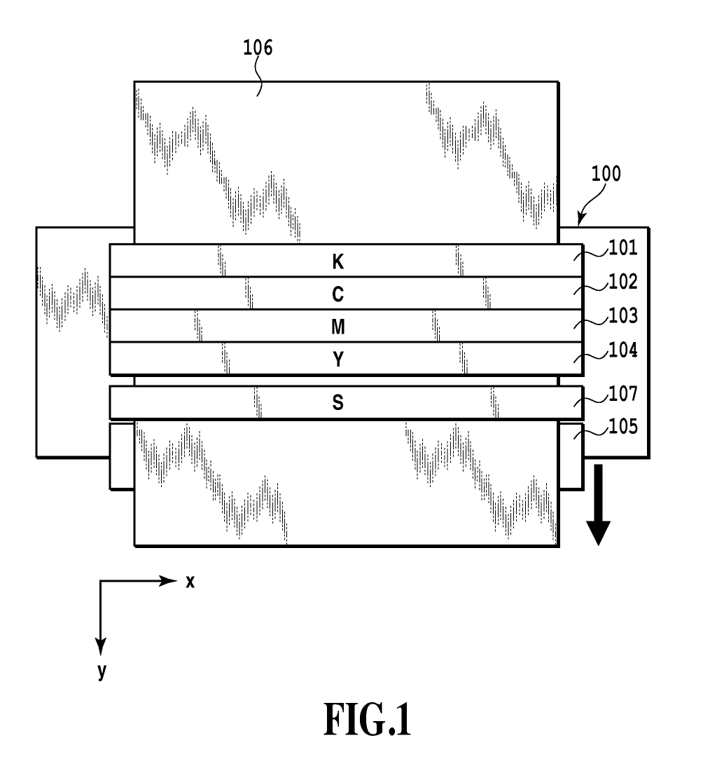

FIG. 1 schematically illustrates an inkjet printing apparatus (hereinafter referred to as inkjet printer) in accordance with an embodiment of the present invention. The printer in the present embodiment is a full-line type printing apparatus, and as illustrated in FIG. 1, the printer is provided with four nozzle arrays 101 to 104 on a frame that acts as the printer's structural member. On each of the nozzle arrays 101 to 104, a plurality of nozzles ejecting the same type of ink is arranged along the X direction at a pitch of 1200 dpi and in accordance with the width of the printing paper 106. The nozzle arrays 101 to 104 eject black (K), cyan (C), magenta (M), and yellow (Y) ink, respectively. By arranging these nozzle arrays 101 to 104 ejecting multiple inks in the Y direction parallel to each other, the print heads of the present embodiment are realized.

Printing paper 106 used as a printing medium is conveyed in the y direction that is orthogonal to the x direction in the figure by rotation of a conveying roller 105 (and other rollers not illustrated in the figure) driven by driving force of a drive motor (not illustrated in the figure). While the printing paper 106 is being conveyed, a plurality of printing nozzles in each of the print heads 101 to 104 eject ink according to printing data and at a frequency that corresponds to the conveyance speed of the printing paper 106. By doing so, respective color dots corresponding to the printing data are printed at a specified resolution, and an image is formed on one sheet of printing paper 106.

At a position downstream to the nozzle arrays 101 to 104 in the Y direction, a scanner 107 is disposed, with scanning elements arranged at a predetermined pitch parallel to the nozzle arrays 101 to 104. The scanner 107 is able to scan the image printed by the nozzle arrays 101 to 104, and output the result as multi-valued RGB data.

It should be appreciated that a printing apparatus to which the present invention can be applied is not limited to the full-line type apparatus described above. For example, the present invention may also be applied to a serial type printing apparatus, wherein printing is conducted by scanning the print heads and scanner in the direction orthogonal to the conveying direction of the printing paper.

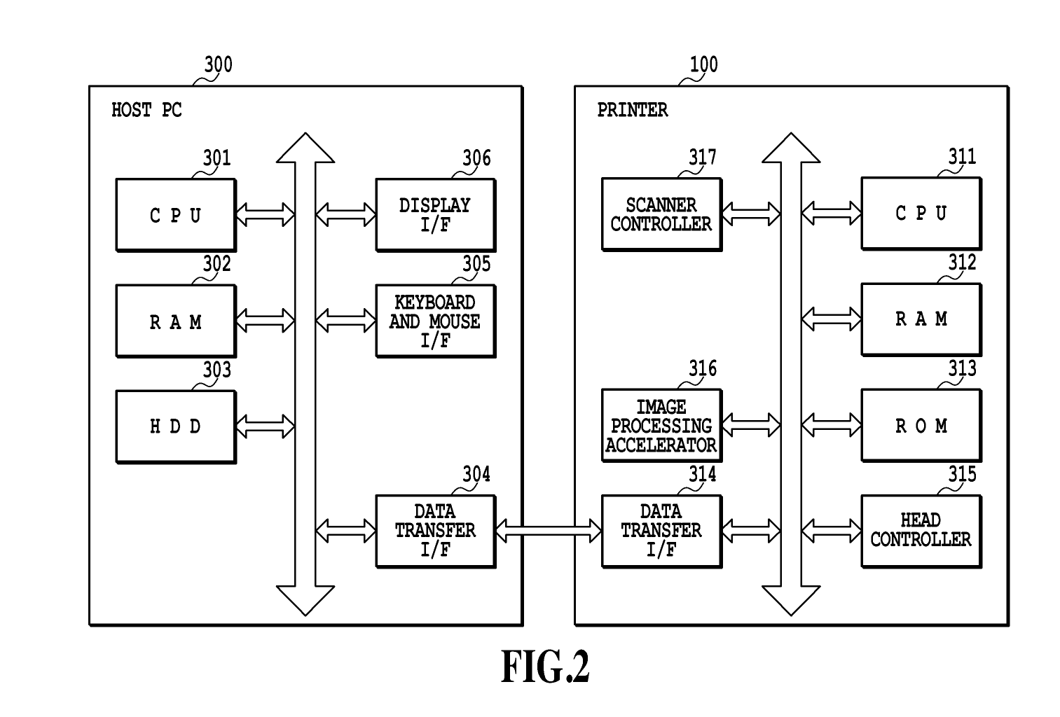

FIG. 2 is a block diagram illustrating a printing system in accordance with an embodiment of the present invention. As illustrated in FIG. 2, the printing system includes the printer 100 illustrated in FIG. 1, as well as a personal computer (PC) 300, which acts as a host device.

The host PC 300 primarily includes the following components. The CPU 301 executes processes according to programs stored in the HDD 303 and the RAM 302. The RAM 302 is volatile storage, and temporarily stores programs and data. The HDD 303 is non-volatile storage and similarly stores programs and data. In the present embodiment, the MCS data characteristic to the present invention and hereinafter described is also stored in the HDD 303. The data transfer interface (I/F) 304 controls the sending and receiving of data with respect to the printer 100. The connection protocol used for this sending and receiving of data may be USB, IEEE 1394, or LAN, for example. The keyboard/mouse I/F 305 is an I/F that controls a keyboard, mouse, or other human interface device (HID). Via this I/F, the user is able to input information. The display I/F 306 controls the display of information on a display (not shown).

On the other hand, the printer 100 is constructed mainly having the following elements. As will be described later, a CPU 311 executes processing such as computation, control and judgment according to programs stored in a ROM 313 or RAM 312. In other words, the CPU 311 performs the function of a first calculation unit, second calculation unit and correction value calculation unit of the present invention. The RAM 312 is volatile storage that temporarily stores programs and data. The ROM 313 is nonvolatile store that can store table data and programs that are used in processing described later.

The data transfer I/F 314 controls the sending and receiving of data with respect to the PC 300. The head controller 315 supplies print data to each of the nozzle arrays 101 to 104 illustrated in FIG. 1, and also controls the ejection operations of the print heads. More specifically, the head controller 315 may be configured to read control parameters and print data from particular addresses in the RAM 312. When the CPU 311 writes control parameters and print data to the particular addresses in the RAM 312, a process is launched by the head controller 315 and ink is ejected from the print heads. The scanner controller 317 controls the individual scanning elements of the scanner 107 illustrated in FIG. 1, while also outputting the RGB data obtained by these elements to the CPU 311.

The image processing accelerator 316 is hardware that is able to execute image processing faster than the CPU 311. More specifically, the image processing accelerator 316 is configured to read parameters and data relevant to image processing from particular addresses in the RAM 312. When the CPU 311 writes such parameters and data to the particular addresses in the RAM 312, the image processing accelerator 316 is activated, and the data is subjected to predetermined image processing. In the present embodiment, the parameters of a table used by an MCS processor to be hereinafter described are created by a process executed in software by the CPU 311. In contrast, image processing at the time of printing, including the processes of the MCS processor, are executed in hardware by the image processing accelerator 316. It should also be appreciated that the image processing accelerator 316 is not a required component, and that depending on the printer specifications and other factors, both the above process for creating table parameters as well as the image processing may be executed by the CPU 311 alone.

Given the printing system described above, the following will describe embodiments for decreasing color difference caused by individual variations in the ejection characteristics of a plurality of nozzles when printing an image using a plurality of inks.

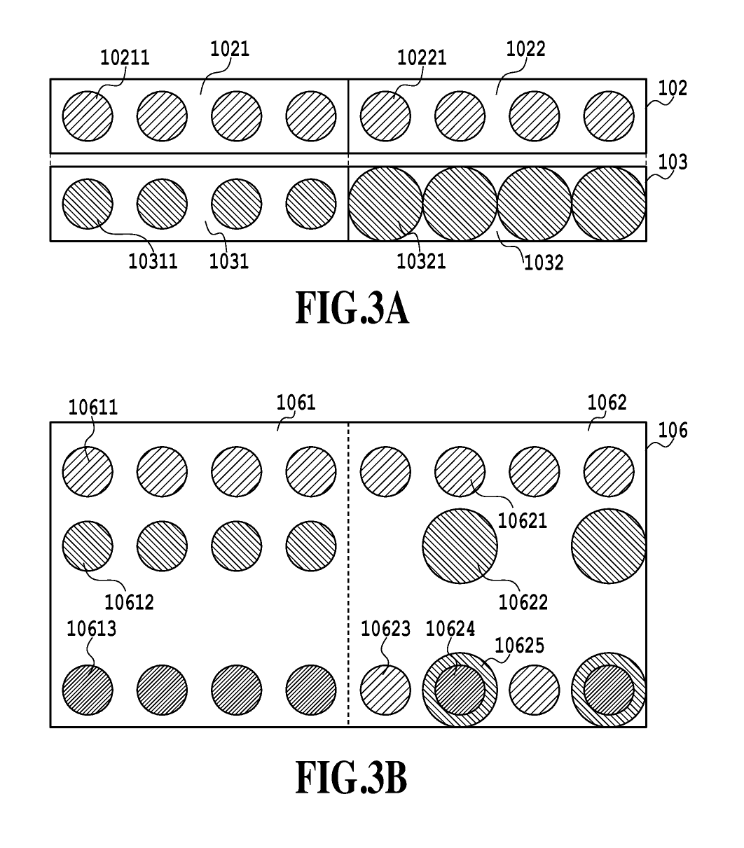

FIGS. 3A and 3B are diagrams for explaining how color difference is produced when printing a blue image expressed by a combination of two inks after having conducted head shading of the related art. In FIG. 3A, 102 represents a print head that ejects cyan ink, and 103 represents a print head that ejects magenta ink. Also, for the sake of simplification in both illustration and description, only eight nozzles from among the plurality of nozzles in each print head are illustrated in FIG. 3A. Also, since color difference will be described for the case of printing blue using cyan and magenta ink, only the two print heads for cyan and magenta are illustrated.

The eight nozzles 10211 and 10221 of the cyan ink print head 102 are all able to eject a standard volume of ink in a standard direction, and same-size dots are printed at equal intervals on the print medium. In contrast, although the ejection directions are all normal for the eight nozzles of the magenta print head 103, the four nozzles 10311 on the left side of FIG. 3A exhibit standard ejection volumes, while the four nozzles 10321 on the right side exhibit greater-than-standard ejection volumes. Consequently, whereas magenta dots equal in size to the cyan dots are printed in the area on the left side of FIG. 3A (the first area), magenta dots larger than the cyan dots are printed at fixed intervals equal to the cyan dots in the area on the right side (the second area).

If image data is corrected by the head shading of the related art when using print heads with such ejection characteristics, then the image data corresponding to the magenta nozzles 10321 will be corrected in a decreasing direction. As a result, dot data (i.e., binary data) specifying whether to print (1) or not print (0) individual dots will be generated such that the number of dots ultimately printed by the magenta nozzles 10321 becomes less than the number of dots printed by the magenta nozzles 10311.

FIG. 3B illustrates how dots are printed in the case where printing is conducted on the basis of dot data resulting from applying head shading correction to a solid image, or in other words, image data wherein both cyan and magenta have 100% duty. For the sake of explanation herein, FIG. 3B illustrates the cyan dots and magenta dots without overlapping. In FIG. 3B, 10611 represents dots printed onto the printing paper by the cyan nozzles 10211, and 10621 represents dots printed onto the printing paper by the cyan nozzles 10221. Also, 10612 represents dots printed onto the printing paper by the magenta nozzles 10311, and 10622 represents dots printed onto the printing paper by the magenta nozzles 10321. In FIGS. 3A and 3B herein, the size of the individual nozzles and the size of the dots printed by each nozzle are illustrated as being equal in size. However, it should be appreciated that the nozzles and dots are illustrated in this way in order to associate the two in the explanation herein, and that in practice the nozzles and dots are not equal in size.

FIG. 3B illustrates the case where the surface area of the dots formed on the printing paper by the magenta nozzles 10321 are double the surface area of the dots formed by the magenta nozzles 10221. In this case, reducing the number of ejections from the magenta nozzles 10321 to approximately ½ (i.e., from four dots to two dots) by head shading the surface area of the printed paper that is covered in magenta of the second area is able to be roughly equal to that of the first area. However, this example of reducing the number of double-area dots to ½ is given to simplify explanation. In actual practice, the relationship between the coverage area and the detected density is not necessarily proportional. Thus, with typical head shading, the number of dots printed in each area is adjusted so that the detected density becomes nearly uniform across all nozzle areas.

FIG. 3B illustrates the results of printing on the basis of dot data obtained by head shading, herein showing the printed state with the cyan dots and magenta dots overlapping each other. In FIG. 3B, in the first area of the printing paper 106, standard size cyan dots and magenta dots are printed overlapping each other, thereby forming standard size blue dots 10613. In contrast, in the second area, standard size cyan dots 10623 are mixed with blue dots formed by the overlap of standard size cyan dots with double-size magenta dots. Furthermore, the blue dots formed by the overlap of standard size cyan dots with double size magenta dots can be subdivided into two areas: a blue area 10624, where the cyan and the magenta are completely overlapping; and a surrounding magenta area 10625.

In the HS process, the numbers of printed dots are adjusted to make the following quantities equal to each other: the total surface area of the cyan areas (i.e., dots) 10623; the total surface area of the blue areas 10624; and the total surface area of the magenta areas 10625. Consequently, if the color observed as a result of the combination of the light absorption characteristics of the cyan areas 10623 with the light absorption characteristics of the magenta areas 10625 is equivalent to the color observed as a result of the light absorption characteristics of the blue areas 10624, then those areas will appear to be almost identical in color to the blue areas 10624. As a result, the blue image in the first area on the printing paper 106 will appear to be the same color as the blue image in the second area.

However, in cases where an area is formed by overlapping a plurality of different inks like the blue areas 10624, the color observed as a result of that area's light absorption characteristics will not necessarily match the color observed as a result of the combination of the light absorption characteristics in the respective areas of the plurality of inks. As a result, for the region as a whole, a color will be produced that is deviated from the standard color intended. This in turn causes the blue image in the first area of the printing paper 106 to be perceived as a different color from the blue image in the second area.

Consider also multi-value printing apparatus wherein the dot size can be changed, such as 4-value printing apparatus that print using three-stage dots (large, medium, and small), for example. Such apparatus are also susceptible to individual variations in the largeness of dots at the respective sizes, due to individual variations in ejection volumes among the nozzles. In these cases, color difference might still be produced due to reasons similar to the above, even if correction is performed by means of the head shading of the related art. Consequently, the present invention is not limited to 2-value printing apparatus, and may also be applied to multi-value (larger than 3-value) printing apparatus.

The embodiments of the present invention that will be explained below reduce color difference by performing MCS (Multi Color Shading) that will be explained below on image data comprising groups of a plurality of color signals.

Here, image processing that includes the basic MCS process that will be performed in the embodiments will be explained first based on FIG. 1 to FIG. 11.

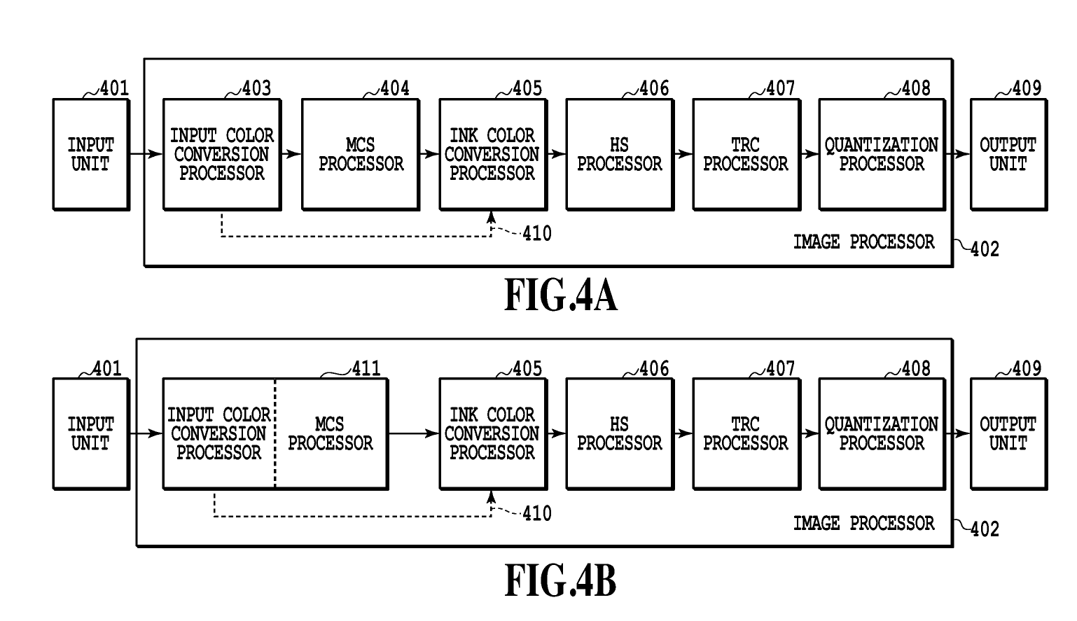

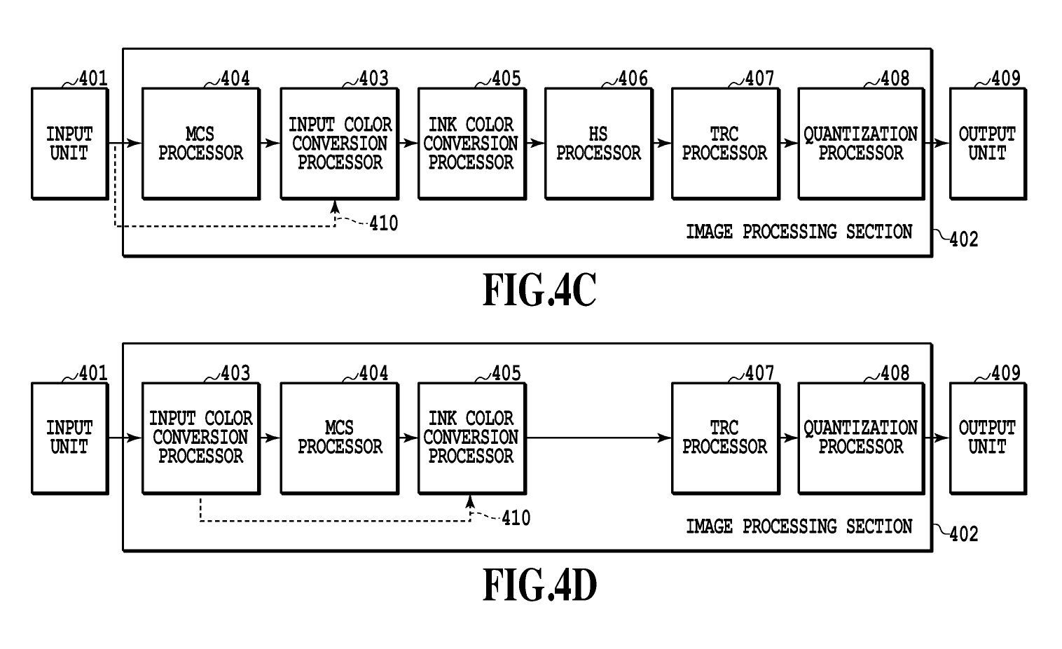

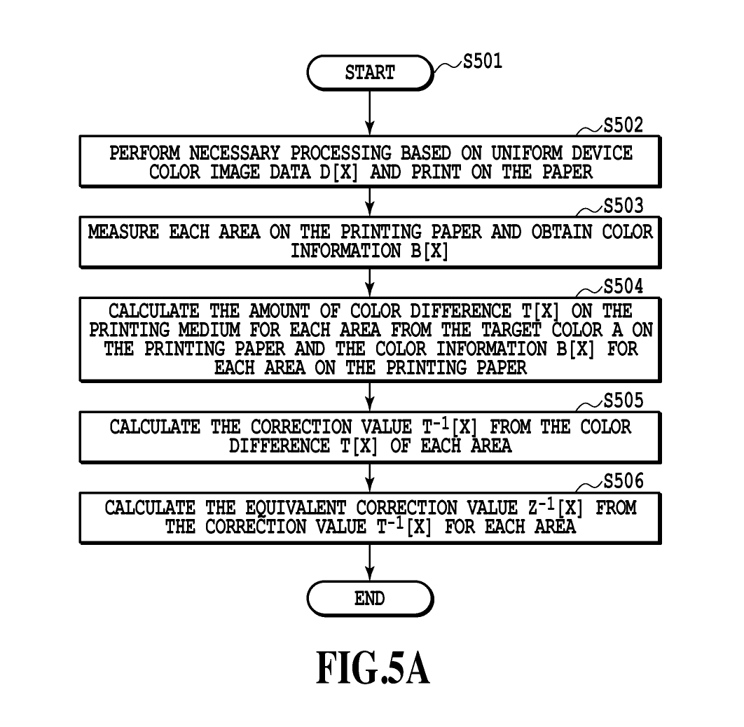

FIG. 4A is a block diagram illustrating the image processing that is executed by an inkjet printing apparatus of a first embodiment of the present invention. In other words, an image processor is constructed by elements for controlling the printer 100 illustrated in FIG. 2 and for performing processing. Of course, application of the present invention is not limited to this form. For example, the image processor can be provided in the PC 300 illustrated in FIG. 2, or part of the image processor can be provided in the PC 300 and the remaining part provided in the printer 100.

As illustrated in FIG. 4A, the input unit 401 takes image data received from the host PC 300, and outputs the image data to the image processor 402. The image processor 402 includes an input color conversion processor 403, an MCS processor 404, an ink color conversion processor 405, an HS processor 406, a TRC processor 407, and a quantization processor 408.

In the image processor 402, first the input color conversion processor 403 takes the input image data received from the input unit 401, and converts the data into image data compatible with the printer's color reproduction range. In the present embodiment, the input image data is data that indicates color coordinates (R, G, B) in a color coordinate space, such as the sRGB space used for expressing color on monitors. By using an established technique availing of such as matrix operations, a 3D LUT, or other processing, the input color conversion processor 403 converts the input image data R, G, and B of 8-bit into image data (R′, G′, B′) in the printer's color reproduction range. This image data is expressed as a color signal made up of three elements. In the present embodiment, the conversion process is conducted using a three-dimensional lookup table (LUT) in conjunction with interpolation operations. Also, in the present embodiment, the resolution of the 8-bit image data handled in the image processor 402 is 600 dpi, whereas the resolution of the binary data obtained by the quantization of the quantization processor 408 is 1200 dpi, as described later.

The MCS (multi-color shading) processor 404 corrects the image data that has been converted by the input color conversion processor 403. As described later, this correction process also uses a correction table made up of a three-dimensional lookup table. By means of this correction process, the color difference described earlier can be reduced, even when there exist individual variations in the ejection characteristics among the nozzles of the print heads at the output unit 909. The specific contents of the table as well as the correction process executed by the MCS processor 904 that uses the table will be described later.

The ink color conversion processor 905 takes the image data containing the 8-bit R, G, and B that were processed by the MCS processor 404, and converts the image data into image data that is in accordance with the color signal data of the inks used by the printer. Since the printer 100 of the present embodiment uses black (K), cyan (C), magenta (M), and yellow (Y) inks, the RGB signal image data is converted into image data made up of 8-bit color signals for K, C, M, and Y, respectively. This color conversion is conducted using a three-dimensional lookup table in conjunction with interpolation operations, similarly to the process executed by the input color conversion processor described above. However, as described earlier, other conversion techniques such as matrix operations may also be used.

The head shading (HS) processor 406 accepts the ink color signal image data as input, and converts the respective 8-bit data for each ink color into ink color signal image data according to the individual ejection volumes of the nozzles that constitute the print heads. In other words, the HS processor 906 conducts a process that is similar to the head shading process of the related art. In the present embodiment, this HS process is conducted using a one-dimensional lookup table.

The TRC (tone reproduction curve) processor 407 takes the image data made up of respective HS-processed 8-bit ink color signals, and for each ink color, the TRC processor 907 corrects the ink color signals in order to adjust the number of dots printed by the output unit 409. Typically, the number of dots printed onto a print medium does not exist in a linear relationship with the optical density realized on the print medium as a result of that number of dots. Consequently, the TRC processor 907 corrects the respective image data of 8-bit signal so as to adjust the number of dots printed onto the print medium in keeping with a linear relationship.

The quantization processor 408 quantizes the 8-bit, 256-value image data for each ink color that was processed by the TRC processor 407, and generates binary data of 1-bit that specify whether to print (1) or not print (0). The configuration of the quantization processor 408 is not particularly limited in the application of the present invention. For example, the quantization processor 408 may be configured to directly convert the 8-bit image data into binary data (dot data), or alternatively, the quantization processor 408 may first quantize the multi-value data into a multi-valued data of several-bit, and then convert the quantized results into the final binary data. The method used for the quantization process may be an error diffusion method, a dithering method, or some other halftoning process.

On the basis of the binary data (dot data) obtained by quantization, the output unit 409 prints by driving the print heads and ejecting ink of respective colors onto a print medium. In the present embodiment, the output unit 409 is realized by means of a printing mechanism provided with the nozzle arrays 101 to 104 illustrated in FIG. 1.

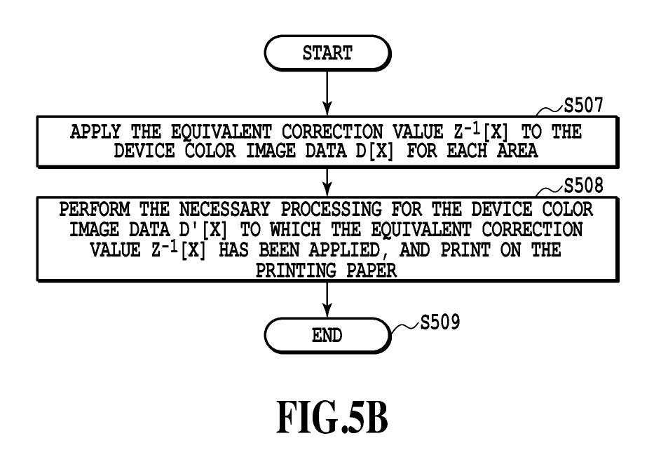

FIGS. 5A and 5B are flowcharts for explaining, respectively, a process for generating the parameters of a table used by the MCS processor illustrated in FIG. 4A, and a process for executing image processing using parameters generated at the actual time of printing.

FIG. 5A is a flowchart for explaining the processes that are executed by the CPU 311 in order to generate parameters of a three-dimensional lookup table that is used by the MCS processor 404. In this embodiment, processing for generating these parameters is forcibly or selectively executed at the time the printer is manufactured, when the printer is used for a specified period of time, or when printing a specified amount. Also, for example, each time printing is performed, the process can be executed before that printing operation. In other words, that processing can be performed as a so-called calibration, and by doing so, the table parameters, which are the contents of the lookup table, are updated.

FIG. 5B is a flowchart illustrating a process of an MCS processor 404, which is executed by the image processing accelerator 316 as one loop in the image processing of the image processor 402 illustrated in FIG. 4A in order to generate print data used when the printer prints.

First, a process for generating the table parameters illustrated in FIG. 5A will be described. In the present embodiment, the table parameters for the MCS processor are created on the assumption that the table parameters for the HS processor 406 have been created. For this reason, at the time when step S501 of the present process is activated, the table parameters for the HS processor have already been generated (or updated) by an established method. Since the generation of table parameters for the HS processor involves suppressing density variations on the print medium for each ink, correction parameters are created so as to reduce the number of ejections from nozzles with large ejection volumes, and to increase the number of ejections from nozzles with small ejection volumes, for example. Consequently, when given the nozzles 10321 of the magenta head 103 illustrated in FIG. 3A, for example, parameters are created so as to reduce the number of dots to approximately ½, as illustrated in FIG. 3B. When given the cyan head 102, parameters are created so as to not change the number of dots, as illustrated in FIG. 3B. In this way, when generating or updating table parameters for the MCS processor in the present embodiment, table parameters for the HS processor are first completed. As a result, when generating correction parameters for the MCS processor, it becomes possible to suitably reduce color difference due to individual variations in ejection characteristics among nozzles by means of the combined processes of the MCS processor and the HS processor.

After the process for generating table parameters for the MCS processor has begun, first, in step S502, a measurement image (patch) is printed on the printing medium by ejecting ink from all of the nozzles of the print head illustrated in FIG. 1. In this case, for each of R, G and B, the signal value 0 to 255 is divided into, for example, 17 equal parts, and a patch can be printed for each combination (grid points) 17×17×17. Moreover, in order to reduce the amount of memory and work time used, it is possible to select grid points for which it is particularly easy for color difference to change due to the ejection characteristics from among all of the aforementioned grid points, and print patches only for the R, G, B combinations that correspond to these grid points. In addition, R=0, G=0, B=255 that correspond to the blue image explained using FIG. 3B can be included in one of these grid points. Selection of the color (grid point) for printing the measurement image is performed, for example, by setting an R, G, B combination for which color difference becomes a specified amount or greater according to the ejection amount, and setting the type (color signal combination) and number of patches according to the calculation load and memory capacity.

Hereinafter, a method for printing measurement images will be described in association with FIG. 4A. When printing patches, image data (R, G, B) for the selected combinations is input into the ink color conversion processor 405 as image data processed by the input color conversion processor 403 (hereinafter, this image data is referred to as device color image data D[X]), without passing through the MCS processor 404. This path is illustrated as the bypass path in FIG. 4A indicated by the broken line 410. This process involving a bypass path may also be conducted by preparing a table wherein input values equal output values, such that the device color image data D[X] is input into the MCS processor 404, but output with values that are equal to the input values regardless of X, for example.

Subsequently, processing similar to that of normal data is performed by the HS processor 406, the TRC processor 407, and the quantization processor 408, and measurement images are printed onto the printing paper 106 by the output unit 409. During this process, the image data for the measurement images expressed with (R, G, B) is converted into image data (C, M, Y, K) for ink color signals by the ink color conversion processor 405. At this point, if one of the image data for the measurement images is R=0, G=0, B=255, for example, then that color signal will be converted into the color signal (K, C, M, Y)=(0, 255, 255, 0) which is a image data indicating cyan and magenta are printed 100% respectively. Subsequently, by means of the processes of the HS processor 406 and thereafter, the image data (K, C, M, Y)=(0, 255, 255, 0) becomes the dot data illustrated in FIG. 3B and is printed. For the sake of simplicity in the following description, table parameters and their generation process will be described only for the parameters corresponding to the lattice point indicated by the image data for such a blue measurement image.

Herein, X is information indicating nozzle positions, in 4-nozzle units, in the X direction on the nozzle arrays 101 to 104 illustrated in FIG. 1. In the MCS processor of the present embodiment, processing is performed in divided units of four nozzles each, and image data is corrected in units of four nozzles each. Also, the device color image data D[X] herein represents the image data to be printed by the four nozzles corresponding to X for respective ink colors.

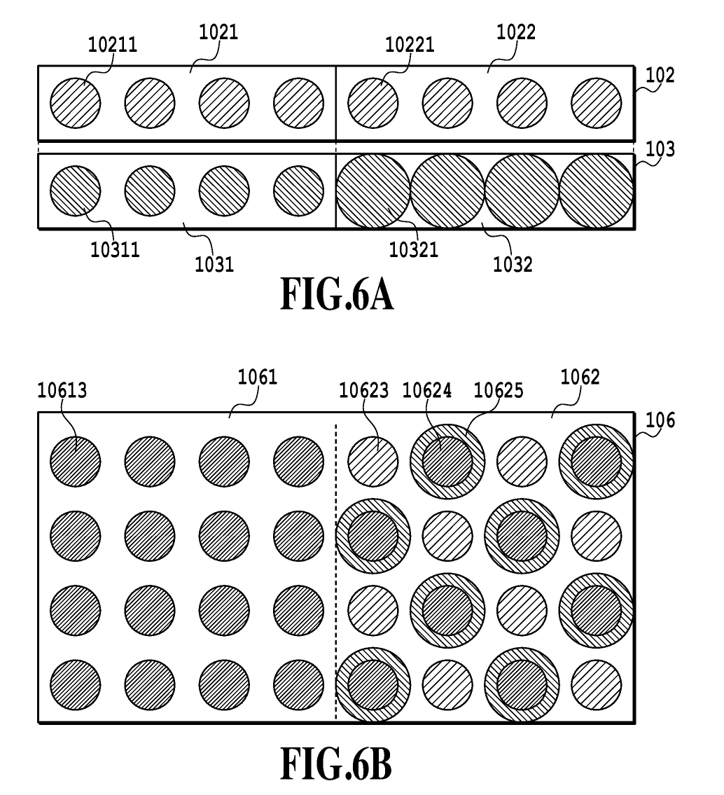

FIGS. 6A and 6B are diagrams for explaining the printed state of measurement images in the above step S502. In FIGS. 6A and 6B, elements that are similar to the elements illustrated in FIGS. 3A and 3B are given identical reference numbers, and further description of such elements is herein omitted.

Similarly to FIG. 3A, FIG. 6A illustrates the case where the four nozzles corresponding to the second area from among the nozzles on the magenta print head 103 have greater-than-standard ejection volumes. Consequently, a blue measurement image like that illustrated in FIG. 6B is printed as a result of the HS process performed on the image data (K, C, M, Y)=(0, 255, 255, 0) expressing blue. In other words, a patch is printed wherein color difference is produced in the second area corresponding to nozzles with greater-than-standard ejection volumes, and wherein the color of the second area differs from the standard blue of the first area.

Referring back to FIG. 5A, in step S503, the measurement images that were printed on the printing paper 106 in step S502 are measured by the scanner 107, and color information B[X] (i.e., RGB data) corresponding to each area X is obtained. In the present embodiment, the resolution of the scanner, that is the pitch of the scanning elements disposed in the scanner, is not particularly limited. The scanner resolution may be higher or lower than 1200 dpi, the print resolution of the print heads. Also, the scanner 107 is not limited to being full-line type like the print heads as illustrated in FIG. 1, and may instead be a serial type device that measures color at a predetermined period while moving along the x direction in FIG. 1. Alternatively, the scanner may be a physically separate device from the printer. In this case, the scanner and the printer may be connected via signals, with the measurement results from the scanner being automatically input. Furthermore, the color information B[X] is not limited to being RGB information, and may be in any format, such as L*a*b* values measured by a color meter, for example. Regardless of which format and which resolution are used to measure color, any technique may be applied to the present embodiment, as long as color measurement results B[X] are suitably obtained for areas corresponding to 4-nozzles sections by performing various processes such as averaging process for example.

In this way, a blue measurement image for the lattice point whose device color image data D[X] is (R, G, B)=(0, 0, 255) is printed by the cyan and magenta print heads 102 and 103 illustrated in FIG. 1. Subsequently, color information B[X] is obtained by the scanner 107 in units of areas corresponding to four nozzles each.

In the following description, the first area is taken to be X=1, the second area is taken to be X=2, the first area color information is taken to be B[1]=(R1, G1, B1), and the second area color information is taken to be B[2]=(R2, G2, B2).

In step S504, a color difference quantity T[X] for each area [X] is computed from a target color A=(Rt, Gt, Bt) as well as the color information B[X] acquired in step S503. Herein, the target color A is a target measurement value in a case wherein a (R, G, B)=(0, 0, 255) signal is printed and measured with the printer in the present embodiment. The target color A may also be the actual color result measured by the scanner 107 for an image that has been printed using nozzles with standard ejection volumes.

In other words, the color difference T can be expressed as follows:

Color deviation T[1]=B[1]−A=(R1−Rt,G1−Gt,B1−Bt)

Color deviation T[2]=B[2]−A=(R2−Rt,G2−Gt,B2−Bt)

In the present example, in the first area, both cyan and magenta have standard ejection volumes. For this reason, R1=Rt, G1=Gt, and B1=Bt, and the color difference becomes T[1]=0 generally. In contrast, in the second area, cyan has a standard ejection volume, but magenta has a greater-than-standard ejection volume. For this reason, values different from the target colors (Rt, Gt, Bt) are inevitably detected. By way of example, consider R2<Rt, G2=Gt, and B2=Bt. In this case, the coloration is such that cyan is stronger compared to the standard blue color, and the color difference becomes T[2]=((R2−Rt≠0), 0, 0).

In the next step S505, a correction value T⁻¹[X] is computed from the color difference T[X] for each area [X]. In the present embodiment, correction values are simply obtained using the inverse transform

T⁻¹[X]=−T[X]

Consequently, the respective correction values for the first and second areas become

T⁻¹[1]=−T[1]=A−B[1]=(Rt−R1,Gt−G1,Bt−B1)

T⁻¹[2]=−T[2]=A−B[2]=(Rt−R2,Gt−G2,Bt−B2)

Herein, since T[1]=0, the correction value for the first area becomes T⁻¹[1]=0. In contrast, since T[2]=((R2−Rt≠0), 0, 0), the correction value for the second area becomes T⁻¹[2]=((Rt−R2≠0), 0, 0). If R2<Rt, then Rt−R2 becomes a positive value, and thus the correction value strengthens red tint to reduce cyan. If the opposite is true and R2>Rt, then Rt−R2 becomes a negative value, and thus the correction value weakens red tint to increase cyan.

In step S506, an equivalent correction value Z⁻¹[X] is computed from the correction value T⁻¹[X] for each area. A equivalent correction value refers to a correction value for taking the correction value T⁻¹[X] that was obtained in the measured color space, and realizing that correction value in the device color space used in the present embodiment. The equivalent correction values are also the table parameters of the MCS processor. For the first area, since the correction value in the color meter space is T⁻¹[1]=0, the equivalent correction value in the device color space is likewise Z⁻¹[1]=0. In contrast, for the second area, a non-zero value is obtained, and in the present example, a correction value that reduces cyan in the device color space is obtained.

Assuming that the color meter space and the device color space match completely, the equivalent correction values become

Z⁻¹[1]=T⁻¹[1]=−T[1]=A−B[1]=(Rt−R1,Gt−G1,Bt−B1)

Z⁻¹[2]=T⁻¹[2]=−T[2]=A−B[2]=(Rt−R2,Gt−G2,Bt−B2)

However, the color spaces often do not match in typical situations, and thus color space conversion becomes necessary. At this point, if a linear transformation is possible between the two color spaces, then a matrix transformation like the following or other established techniques can be used to compute equivalent correction values.

$$\begin{matrix}{Z}^{- 1} [ 1 ] = [ \begin{matrix}a 1 & a 2 & a 3 \\ a 4 & a 5 & a 6 \\ a 7 & a 8 & a 9\end{matrix} ] \times [ \begin{matrix}Rt - R 1 \\ Gt - G 1 \\ Bt - B 1\end{matrix} ] & [ Eq . 1 ] \\ {Z}^{- 1} [ 2 ] = [ \begin{matrix}a 1 & a 2 & a 3 \\ a 4 & a 5 & a 6 \\ a 7 & a 8 & a 9\end{matrix} ] \times [ \begin{matrix}Rt - R 2 \\ Gt - G 2 \\ Bt - B 2\end{matrix} ] & [ Eq . 2 ]\end{matrix}$$

Herein, a1 to a9 are transform coefficients for transforming the measured color space into the device color space.

In contrast, if a linear transformation is not possible between the two color spaces, then a three-dimensional lookup table or other established technique may be used to evaluate

Z⁻¹[1]=F(Rt−R1,Gt−G1,Bt−B1)

Z⁻¹[2]=F(Rt−R2,Gt−G2,Bt−B2)

wherein F is a function for transforming the measured color space into the device color space, and wherein the transformation relationship of the lookup table is in accordance with this function F.

Also, if the relationship between the correction value T⁻¹ and the equivalent correction value Z⁻¹[X] differ depending on the color, then a three-dimensional lookup table or other established technique may be similarly used to evaluate

Z⁻¹[1]=F(Rt,Gt,Bt)−F(R1,G1,B1)

Z⁻¹[2]=F(Rt,Gt,Bt)−F(R2,G2,B2)

wherein F is a function for transforming the measured color space into the device color space.

In so doing, a table parameter for each area [X] corresponding to particular nozzles can be computed with respect to lattice points selected as the colors particularly susceptible to significant color difference. Additionally, the table parameters for lattice points other than the above selected lattice points can be computed by interpolating between the selected lattice points. The method used to compute values by means of interpolation may be an established method, and further description thereof is herein omitted.

The table parameters for each lattice point (i.e., the equivalent correction values Z⁻¹[X]) computed as above are stored in memory for each area [X] and in association with their lattice points (correction parameter configuration). The memory used to store values at this point is herein taken to be the HOD 303 of the host PC in the present embodiment, but may also be non-volatile memory provided inside the printer itself. In either case, the created table parameters are preferably handled so as to not be lost at power off or similar timings. With the above, the calibration process is terminated.

Steps in the process executed by the MCS processor 404 and illustrated in FIG. 5B will now be described. These steps are one portion of the steps executed by the image processing accelerator 316 during normal printing operations, and following the series of image processing operations illustrated in FIG. 4A. In FIG. 4A, these steps correspond to the steps executed in the MCS processor 404.

First, in step S507, the image processing accelerator 316 corrects the device color image data D[X] (i.e., the first color signal) by using the table parameters created as illustrated in FIG. 5A (i.e., by using the equivalent correction values Z⁻¹[X]).

At this point, it is first determined which of the above areas [X] includes the target pixel which is the pixel currently subject to image processing. In other words, the value of X is determined. At this point, although each area [X] corresponds to a region made up of four 1200 dpi nozzles, the pixel resolution in the image processing is 600 dpi. For this reason, each area X corresponds to two pixels in the X direction.

If the value X=n is obtained for the area [X] that contains the target pixel, then by referring to the table entries created with respect to this area [n], an equivalent correction value Z⁻¹[n] can be acquired from the (R, G, B) values expressed by the image data of the target pixel. For example, if the RGB values expressed by the image data of the target pixel represent blue (0, 0, 255), then the equivalent correction value Z⁻¹[n] for blue (0, 0, 255) is obtained with respect to the area [n] as described earlier. The equivalent correction value Z⁻¹[n] is then added to the target pixel image data according to the equation below, and corrected device color image data D′[X] (i.e., the second color signal) is obtained. In other words, the relationship between the first color signal D[X] and the second color signal D′[X] is as follows.

Device color image data D′[1]=D[1]+Z⁻¹[1]

Device color image data D′[2]=D[2]+Z⁻¹[2]

In this example, the equivalent correction value for the first area is Z⁻¹[1]=0. Consequently, D′[1]=D[1], and thus the correction of the image data in the first area is, in effect, not performed by the MCS processor. In contrast, the equivalent correction value for the second area is Z⁻¹[2] ≠0. Consequently, correction is performed by the MCS processor such that cyan is reduced in D′[2] compared to D[2].

In the following step S508, the image processing accelerator 316 takes the device color image data D′[X] obtained in step S507, and performs processing corresponding to the ink color conversion processor 405, the HS processor 406, the TRC processor 407, and the quantization processor 408. Dots are then printed onto the printing paper 106 by the output unit 409 in accordance with the binary data obtained as a result of the above processing.

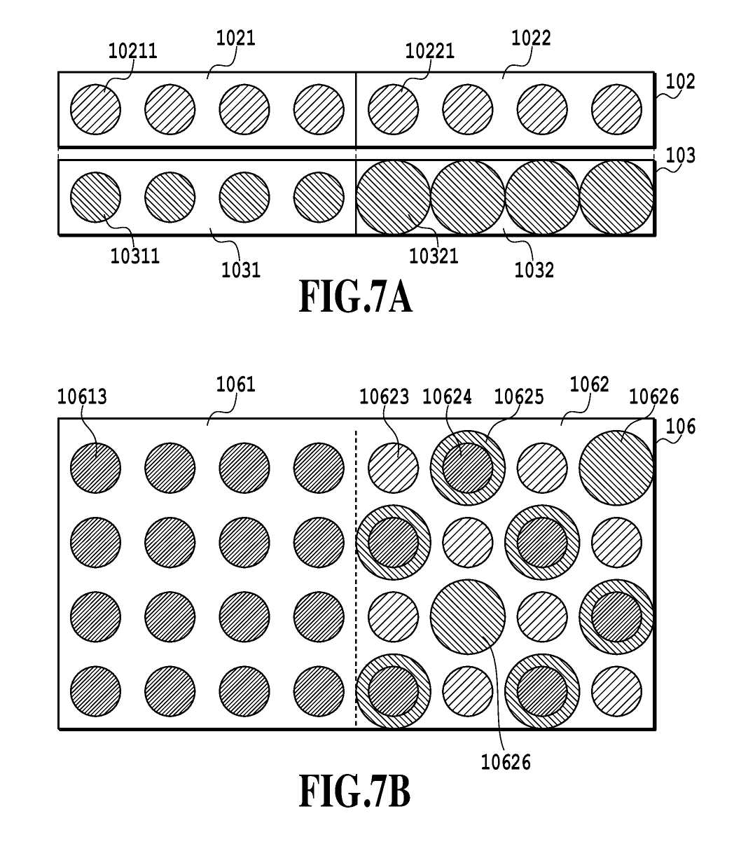

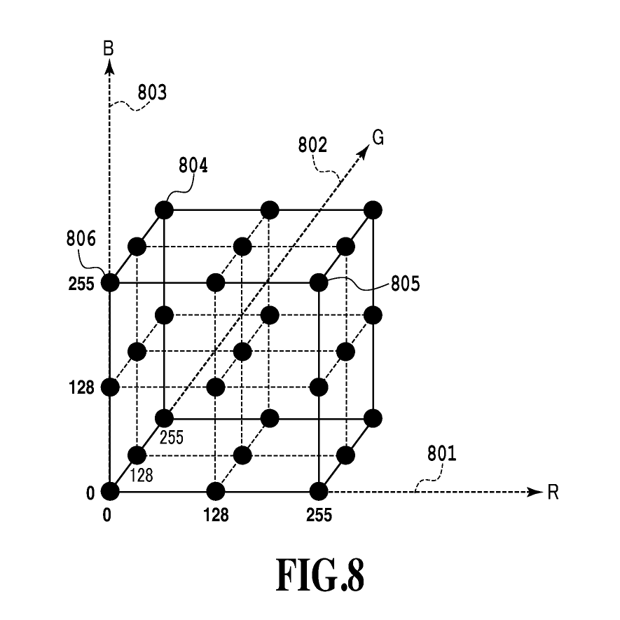

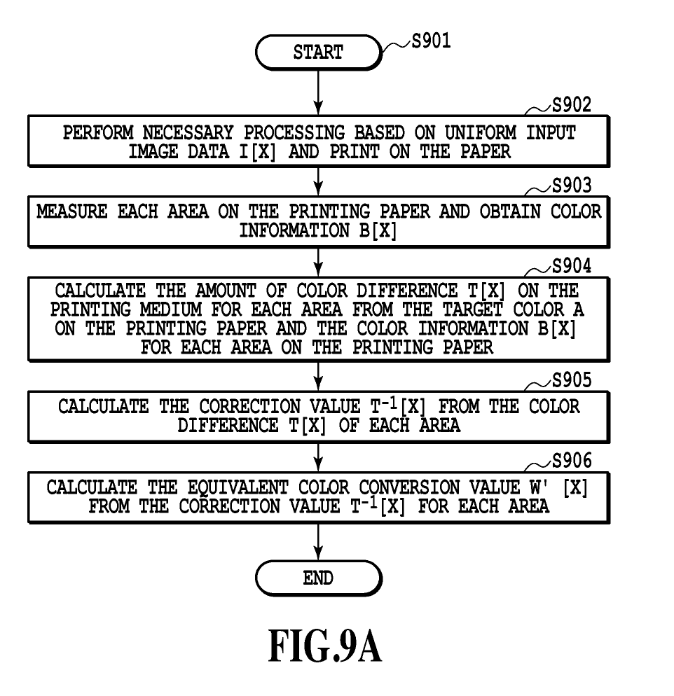

FIGS. 7A and 7B illustrate examples of images printed in step S508 of FIG. 5B. Similarly to FIG. 6A, FIG. 7A illustrates the nozzle ejection volume characteristics for the cyan and magenta print heads 102 and 103. FIG. 7B is a printed state of dots obtained as a result of conducting the MCS process of the present embodiment for comparing to the printed state of dots obtained as a result of conducting only the HS process illustrated in FIG. 6B. Given the state illustrated in FIG. 6B where only the HS process has been conducted, the second area is determined to have a strong cyan tint, and thus the MCS process is conducted so as to generate D′[2] with reduced cyan tint compared to D[2]. As a result, the number of cyan dots 10624 has been reduced compared to the printed state resulting from conducting only the HS process as illustrated in FIG. 6B.

In the first and second areas actually printed onto printing paper in accordance with D′[1] and D′[2], some degree of inevitable color difference T[X] is produced due to ejection volume variation and other factors, but the resulting color is sufficiently close to the target color A.

Actual coloration in first area=Printed color corresponding to D′[1]+T[1]≈A

Actual coloration in second area=Printed color corresponding to D′[2]+T[2]≈A

Herein, D′[1] is ideally equivalent to the target color A, and T[1] is ideally 0. D′[2] is a blue color which is cyan-reduced color by amount equivalent to T[2] from the target color A, and T[2] is the amount of color difference causing increased cyan. In this way, the blue colors in the first and second areas become nearly the same color, and the color unevenness due to a color difference between the two areas can be reduced.

As described above, the present embodiment is configured such that measurement images (i.e., patches) are printed onto a print medium for colors (i.e., combinations of R, G, and B) that are susceptible to significant color difference, and table parameters are then computed on the basis of the measurement results. Typically, the susceptibility to color difference depends on both (1) the color itself to be printed, and (2) the printing characteristics of the respective inks with respect to the print medium. Regarding (1), there is the issue of, for example, blue color difference being more noticeable than red color difference, even for equivalent variations in ejection volumes. Regarding (2), there are various factors that influence the size and density of dots as well as the coloration of respective inks in overlapping dots. In addition to ejection volumes, such factors can include the ejection direction, the dot shape, the permeability, and the type of print medium, for example.

Meanwhile, it is clear that the degree of color difference for a particular color depends on the combination of the printing characteristics of the inks used to print that color, and does not depend on the printing characteristics of the inks that are not used. In other words, the type and number of related ink colors differs for each pixel, and thus it is possible in some cases that only a single ink will be related to particular pixels, and color difference will not occur.

Also, although the foregoing describes, by way of example, a case where the four magenta nozzles contained in the same area all exhibit greater-than-standard ejection volumes, there is a significant possibility that the ejection characteristics for each nozzle inside a single area will all be different. However, it is still possible to achieve the advantages described above in such cases by acquiring the average color difference for a given area, and processing so as to correct the color difference by means of all four nozzles.

Meanwhile, data that can be expressed by the solid colors of the respective inks used by the printing apparatus is already adjusted in concentration by the ES process, and thus color difference does not occur. Consequently, such colors do not need to be corrected by the MCS processor 404. Such a state will now be specifically described, taking by way of example the case where the measured color space and the device color space match completely.

If the measured color space and the device color space match completely, then the color signal (R=0, G=255, B=255) will be converted to (C=255, M=0, Y=0, K=0) in the ink color conversion processor. Since solid cyan (the C signal) is already suitably adjusted in density by the primary conversion of the HS process, it is better not to further modify the cyan data or add additional color data once the data has been adjusted by the HS process. In other words, in cases where such data exists, the equivalent correction values for the first and second areas should be Z⁻¹[1]=Z⁻¹[2]=0=(0, 0, 0). The above similarly applies to 100% magenta data (R=255, G=0, B=255). In contrast, 100% blue data (R=0, G=0, B=255) is not data that can be expressed with the solid color of one of the inks used by the printing apparatus, and is instead expressed by a combination of cyan ink and magenta ink. Consequently, as already explained with the use of FIG. 3B, there is a possibility that color difference will occur, even if an HS process is conducted. For this reason, the equivalent correction values become

Z⁻¹[1]=0=(0,0,0)

Z⁻¹[2]=T⁻¹[2]=(Rt−R2,Gt−G2,Bt−B2)≠(0,0,0)

in the example illustrated in FIG. 6B, and suitable correction is conducted by means of an MCS process.

In this way, in a three-dimensional RGB space, there exist lattice points that require an MCS process, as well as lattice points that do not require an MCS process, with various degrees of correction depending on the signal value (i.e., the position of the lattice point). Consequently, when it is desirable to suppress color difference across the entire color space, it is desirable to prepare correction signal values for the MCS process with respect to all RGB values expressed using two or more inks. However, printing and measuring patches for all RGB combinations, computing correction values, and preparing space to record the obtained correction values would lead to increased processing load, increased memory requirements, and increased processing time. Thus, it is preferable to select several colors in the RGB space that particularly require color difference correction, print measurement images (patches) with signal values corresponding to those colors, and create a table containing the acquired equivalent correction values for each color, as in the present embodiment. However, in cases where the colors susceptible to significant color difference are not particularly limited, then an embodiment may be configured as illustrated by way of example in FIG. 8, wherein correction values are computed for each of 27 lattice points taken at equally spaced coordinates in RGB space. In either case, patches may be printed for several specific color signals, and table parameters may be created on the basis of the correction values obtained from the patches. In so doing, an interpolation process can be conducted when actually printing an image, and parameters corresponding to the desired signal values can be prepared from the plurality of scattered parameter information.

In the table parameter generation method described earlier, table parameters are described as being created by computing the difference between a target color and the color meter results of an actually-printed patch. However, it should be appreciated that the method for generating correction parameters is not limited to the above. For example, from the measured results of the printed patches for each of the lattice points illustrated in FIG. 8, an outline in RGB color space expressed by the printing apparatus can be ascertained, signal values for realizing the target colors can be estimated, and these signal values may be taken to be the corrected data. This method will now be specifically described.

FIG. 8 illustrates the RGB color space, with 801 representing the red axis, 802 representing the green axis, and 803 representing the blue axis. The black circles represent 27 lattice points, each having red, green, and blue components that take one of the following values: 0, 128, or 255. In the present example, patches are printed on the basis of the respective signal values for these 27 lattice points, and color is measured on a per-area basis. The colors obtained from the color meter results are herein designated the device colors (Ri, Gi, Bi). By interpolating on the basis of the 27 device colors obtained from the 27 patches, a device color space for each area is obtained. Such device color spaces differ from the color space made up of equally spaced and parallel lines as illustrated in FIG. 8, and typically become color spaces with curved outlines. By using such device color spaces, it is possible to estimate device colors (Ri, Gi, Bi) for each area with respect to all target colors (Rt, Gt, Bt). The reverse is also true: it is possible to compute the signal values (Rn, Gn, Bn) for each area that should be input in order to best approximate the target colors (Rt, Gt, Bt). In other words, these device color spaces for each area can be used to create table parameters for converting input signals (Rt, Gt, Bt) into (Rn, Gn, Bn).

### (Variation 1)

FIG. 4B is a block diagram illustrating a different example of the construction of the image processor of an inkjet printing apparatus of this embodiment. In FIG. 4B, the units indicated by reference numbers 401 and 405 to 409 are the same as the respective units indicated by the same reference numbers in FIG. 4A, so explanations of those units are omitted. This variation differs from the construction illustrated in FIG. 4A in that the input color conversion processor and MCS processor are integrated into one processing unit. In other words, the input color conversion processor and MCS processor 411 of this variation is a processing unit having both an input color conversion unit processing function and MCS processing function.

More specifically, the input color conversion processing and MCS processor 411 uses one table that is a combination of a table for the input color conversion processor and a table for the MCS processor. By doing so, it is possible to directly perform correction of color difference of input image data from the input unit 401, and output device color image data for which the color difference has been reduced.

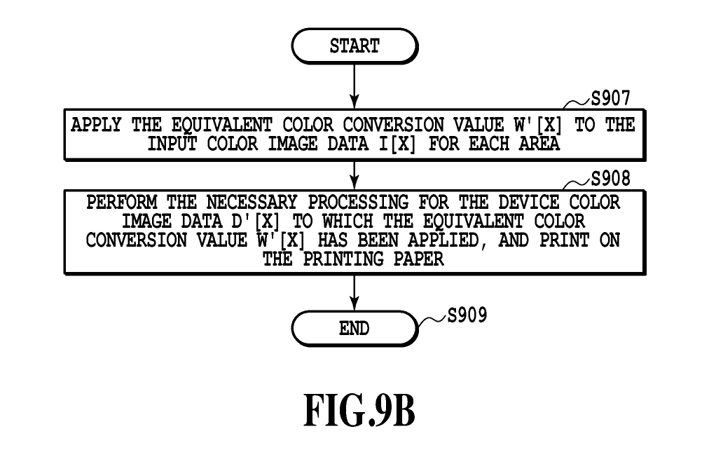

FIGS. 9A and 98 are flowcharts illustrating the process of generating parameter data for the table used by the input color conversion processing and MCS processor 411, and MCS process that uses that table in image processing when generating printing data.

FIG. 9A is a process that the CPU 311 executes for generating parameters for a three-dimensional lookup table and comprises step S902 to step S906. This flowchart differs from the flowchart in FIG. 5A by the processing of step S902 and step S906. The processing of those two steps is explained below.

In step S902, a measurement image for correcting color difference is printed on the printing paper based on input color data I[X] that is inputted from the input unit 401. When doing this, only the part that corresponds to the input color conversion processor of the input color conversion process and MCS processor 411 functions, and the MCS process is skipped by way of the bypass path indicated by the dashed line 410. More specifically, the input color conversion processing and MCS processor 411 is constructed such that it can switch between and use two tables. In other words, the input color conversion process and processing by the MCS processor can switch between and use a table having color conversion values W′ as table parameters obtained by process in which the input color conversion process and MCS process is combined, and a table having only the table parameters of the input color conversion process. In addition, when printing a measurement image, processing is switched to only the table for the input color conversion process.

Taking the color conversion coefficient of the input color conversion process according to the table used in printing this measurement image to be the input color conversion value W, the relationship, “device color data D[X]=input color conversion value W (input image data I[X])”, is established. The uniform device color image data D[X] that is obtained in this way is converted to print data by the ink color conversion processor 405, HS processor 406, TRC processor 407 and quantization processor 408 and the output unit 409 prints a measurement image on the printing paper 106 according to the print data.

In step S906 the equivalent color conversion value W′[X] is calculated as a table parameter from the correction value T⁻¹[X] for each area. This value W′[X] is a color conversion value that is a combination of the aforementioned input color conversion value W and the equivalent color correction value Z⁻¹[X]. Calculation of the equivalent color correction value Z⁻¹[X] is the same as in the first embodiment, so an explanation is omitted.

FIG. 9B is a flowchart illustrating the processing of the input conversion and MCS processor 411, wherein, in order to generate printing data when printing with the printer, the image processing accelerator 316 executes the image processing of the image processor 402 illustrated in FIG. 4B. Here, color difference is corrected by using the equivalent color conversion values W′[X] as table parameters that were created according to the flowchart in FIG. 9A. In other words, together with performing color difference correction on input color image data I[X] that corresponds to each area, also outputs device color image data D′[X] for which color difference correction has been performed. In addition, processing by the ink color conversion processor 405 illustrated in FIG. 4B and later is performed on the device color image data D′[X], and an image is printed on the printing paper by way of the output unit 409.

With this first variation as described above, an equivalent color conversion value W′[X] is set in step S906 so that the device color image data D′[X] becomes the same value as in the first embodiment, so that color difference can be reduced in the same way as in the first embodiment. Moreover, the color conversion value W−¹[X], which is a combination of the equivalent color correction value Z⁻¹[X] and input color conversion value W, is converted all together by one lookup table, so it is possible to reduce the amount of area prepared for the lookup table and improve the processing speed more than in the first embodiment.

### (Variation 2)

FIG. 4C is a block diagram illustrating the construction of an image processor of a second variation of the embodiment. A feature of this variation is that the processing by the MCS processor 404 is performed before the processing of the input color conversion processor 403.

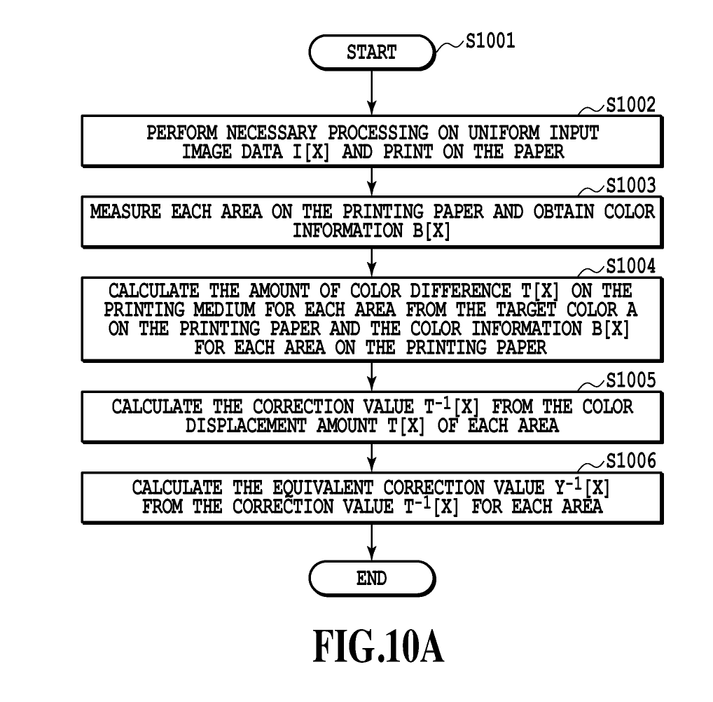

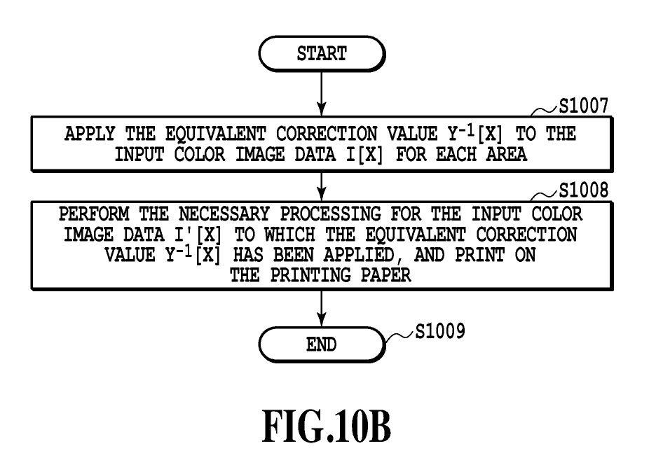

FIG. 10A and FIG. 10B are flowcharts of this second variation and illustrate the processing of generating table parameters to be used by the MCS processor 404, and MCS processing that uses the above table. FIG. 10A differs from FIG. 5A in that there are step S1002 and step S1006, which are explained below.

In step S1002, the input color image data I[X] from the input unit 401 bypasses the MCS processor 404 and is converted to device color data D[X] by the input color conversion processor 403. After that, as in FIG. 4A, the data undergoes processing by the ink color conversion processor 405, HS processor 406, TRC processor 407 and quantization processor 408, and a measurement image is printed on the printing paper 106 by the output unit 409. In addition, in step S1006, an equivalent correction value Y⁻¹[X] that corrects the color of the input color space is calculated. This value is a correction value that corrects the input color equivalent to the equivalent correction value Z⁻¹[X] that was calculated in step S506 of the flowchart in FIG. 5A and that corrects the color of the device color space. This calculation process of calculating this equivalent color correction value Y⁻¹[X] is the same as in the case illustrated in FIG. 5A, so an explanation of the process is omitted.

Next, the processing illustrated in FIG. 10B will be explained. In FIG. 10B, in step S1007, the MCS processor 404 performs correction of the input color image data I[X] for each area by using the table corrected in process step S1010 above and applying the equivalent correction value Y⁻¹[X]. Moreover, in step S1008, the input color image data I′[X] that is corrected by the equivalent correction value Y⁻¹[X] is converted by the input color conversion processor 403 to device color image data D′[X]. The processing after this is the same as that illustrated in FIG. 5B, so an explanation of that processing is omitted.

With this variation, by performing the processing of the MCS processor 404 before the processing of the input color conversion processor 403, independence of the modules is improved. For example, the processing can be provided as an expanded function to image processors not having a MCS processor. Moreover, processing can also be moved to the host PC side.

### (Variation 3)

FIG. 4D is a block diagram illustrating construction of an image processor of a third variation. As illustrated in FIG. 4D, this variation is a form of the embodiment wherein the HS processor 406 that was prepared in FIG. 4A to FIG. 4C is omitted.

Generating table parameters for the MCS processor and the processing of the MCS processor of this variation are the same as illustrated in FIG. 5A and FIG. 5B, the difference of this variation being that head shading by the HS processor is not performed. In other words in this variation, the table parameters of the MCS processor are not created based on data after HS processing as in the embodiment and variations above. In this variation, generating parameters for the table used by the MCS processor and performing image processing can be performed according to the flowchart illustrated in FIG. 5A and FIG. 5B.

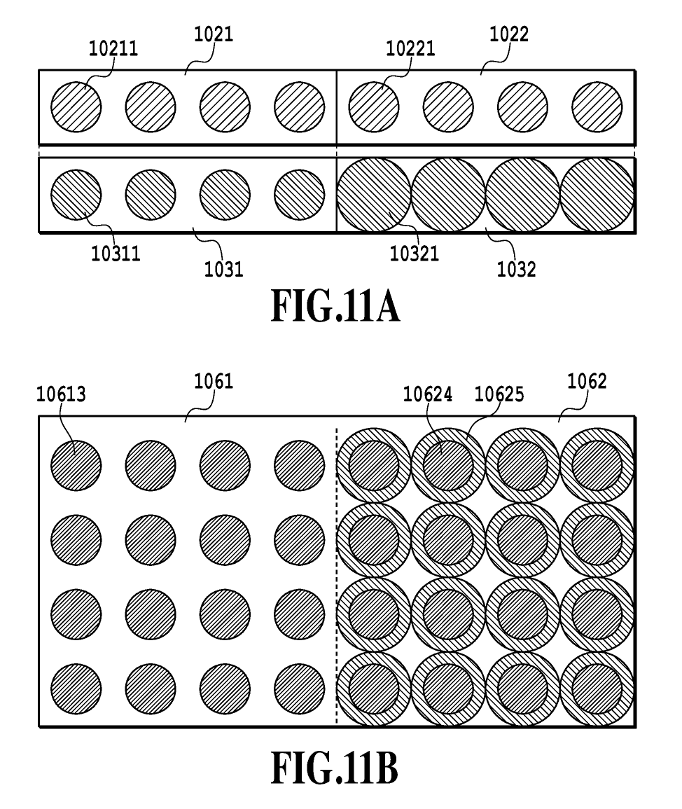

FIG. 11A and FIG. 11B are drawings for explaining the printed state of a measurement image of this variation. FIG. 11A illustrates an example wherein the ejection amount of four nozzles from among the nozzles of the magenta print head 103 that correspond to a second area is greater than the standard amount, and is similar to the example illustrated in FIG. 3A. In this variation, HS processing is not performed on the image data expressing blue color (K, C, M, Y)=(0, 255, 255, 0), so a blue measurement image as illustrated in FIG. 11B is printed. In other words, even in the second area that includes nozzles having an ejection amount that is greater than the standard amount, the same numbers of magenta and cyan dots are printed. As a result, difference occurs from the magenta color in the second area.

As a result of measuring the color of this kind of patch, correction values that will reduce the magenta color are created as the table parameters for the MCS processor 404 of this variation. By performing this kind of correction, it becomes possible to obtain a printed state as illustrated in FIG. 7B when printing blue data and to reduce color difference even in this variation having no HS processor.

Moreover, in this variation having no HS processor, there is no need to prepare a table for HS processing, and thus processes for HS processing such as ‘printing a pattern’, ‘color measurement’ and ‘calculation of correction parameters’ are not necessary. As a result, it is possible to reduce the amount of memory used as well as the time and cost related to HS processing.

A first embodiment and first thru third variations of that embodiment were explained above; however, the processing in that embodiment and variations is only an example, and any construction can be used as long as the reduction of color difference, which is the effect of the present invention, can be achieved. For example, as long as it is possible to reduce relative color difference among areas, color unevenness, which is the problem the present invention solves, becomes unnoticeable, so correction does not necessarily need to be performed for all areas in order that the values approach the desired color A, which is a fixed value. In other words, a desired color can be set according to color tendencies of individual areas so that variation in coloring of individual areas converges.

In addition, in the embodiment above, one area is taken to be the area of four nozzles, and this area is set as the minimum area for which MCS processing is performed: however, of course the present invention is not limited to this kind of unit of area. An area of more nozzles could be taken to be the unit area, or MCS correction could be performed for one nozzle at a time. Moreover, the number of nozzles included in each individual area does not necessarily need to be the same number, and the number of nozzles included in each area can be appropriately set according to the characteristics of the device.

Furthermore, in the embodiment above, an example was explained wherein MCS processing is performed on image data that is inputted in RGB format, after which the data is converted to image data in CMYK format that corresponds to the ink colors used by the printing apparatus. However, of course the present invention is not limited to this form. In addition to RGB format, the image data that is the object of MCS processing can be in any format such as Luv, LCbCr, LCH and the like.

As explained above, in this embodiment, by performing MCS processing, it basically becomes possible to suppress the occurrence of a color difference that occurs due to variation in the ink ejection characteristics of the print heads. However, in actual MCS processing, there are cases where, due to the construction of the printer or the scanner performance, it is not possible to sufficiently suppress the occurrence of color difference. The construction in which the construction of the printer and scanner is made to differ is explained.

For example, when measuring color in the process illustrated in FIG. 5A of generating parameters for MCS processing, there are times when it is not possible to obtain a sufficient effect when measuring the color of an area that corresponds to four nozzles. The following two reasons are considered to be the cause of this.

First, there is the problem of the performance of the colorimeter. When using a device such as a scanner that scans a printing medium, even though the resolution of the read element array is sufficient, actually when affected by a large range that exceeds the resolution range, the color measurement results may not be adequate. Moreover, using a colorimeter having a high MTF (modulation transfer function) increases the cost, so the colorimeter may not have the resolution necessary for the color, and this also becomes the cause of not being able to obtain adequate color measurement results.

Second, is a problem on the printer side. As was explained above, in basic MCS correction, a long array of nozzles is formed in each print head that is used. However, forming a long nozzle array such as this on one substrate is difficult from the aspects of technology and cost. Therefore, long print heads are now being constructed by arranging a plurality of chips having short nozzle arrays, such as are used in print heads for consumers, into a long print head (hereafter, referred to as a joined head). When using this kind of joined head in a printer, when the joints between the plurality of chips take up a large space, the number of head chips per print head increases, thus increasing the cost. Therefore, it is preferred that the joints between head chips be made as small possible. However, in a joined head, the ink ejection characteristics differ at the joints between head chips and sections other than the joints (non-joint sections). Therefore, in order to detect the difference in ejection characteristics, it is necessary to perform detection by dividing a patch into the patch sections formed by joint sections and patch sections formed by non-joint sections. Therefore, when the joint sections of head chips are set to be narrow, it is accordingly necessary to make the range where color measurement is performed narrow, and as a result, it becomes difficult to perform color measurement in a suitable color measurement area.

For the two reasons described above, it is difficult to perform color measurement of a patch for MCS processing in the minimum unit area necessary for color measurement, and this is a cause that prevents being able to achieve suitable MCS processing. On the other hand, the second embodiment of the present invention is able to suitably set parameters (correction values) to be used in MCS processing, and thus is able to improve the effect of reducing color difference due to MCS processing.

### Second Embodiment

First, in explaining the processing for generating parameters for MCS processing of a first embodiment of the present invention, a print head and scanner that is used in this embodiment is described.

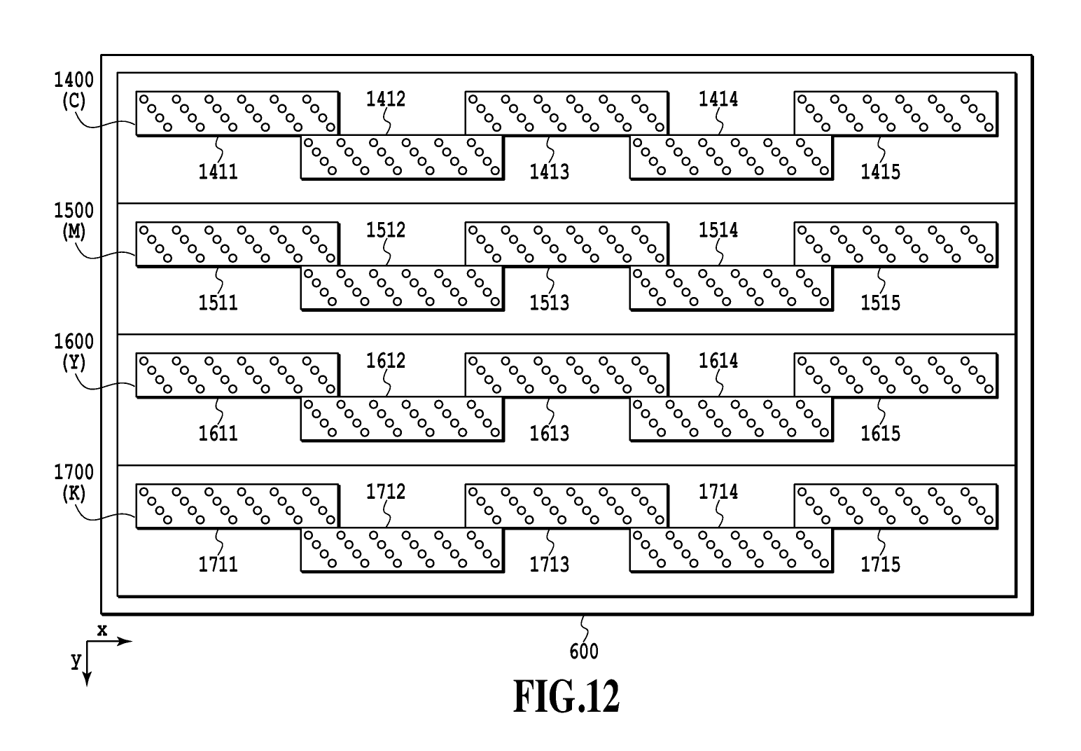

FIG. 12 is a drawing that schematically illustrates a head unit 600 that is used in this embodiment. The head unit 600 that is illustrated here has four print heads 1400, 1500, 1600 and 1700 for ejecting cyan (C), magenta (M), yellow (Y) and black (K) ink. Here, print head 1400 is a cyan print head that ejects cyan ink, print head 1500 is a magenta print head that ejects magenta ink, print head 1600 is a yellow print head that ejects yellow ink and print head 1700 is a black print head that ejects black ink. There are five head chips arranged in each print head. There are 24 nozzles arranged in each of the head chips, each of nozzles in each head chip being arranged at a different position in the direction (x direction) that is orthogonal to the conveyance direction (y direction) of the printing medium, and this forms a nozzle array in the x direction. Each head chip is arranged so that the four nozzles located on the end sections overlap each other in the conveyance direction of the printing medium, and in this way nozzle arrays of adjacent head chips are in a state of being connected together. Therefore, one print head can perform printing by 88 nozzles that are arranged in an array in a direction that is orthogonal to the y direction. Chips 1411 to 1415 are chips that eject cyan ink, chips 1511 to 1515 are chips that eject magenta ink, chips 1611 to 1615 are chips that eject yellow ink, and chips 1711 to 1715 are chips that eject black ink.

On the other hand, as a colorimeter (scanner) in this embodiment, a measurement aperture for measuring the color of an image corresponds to eight dots that are formed by eight nozzles.

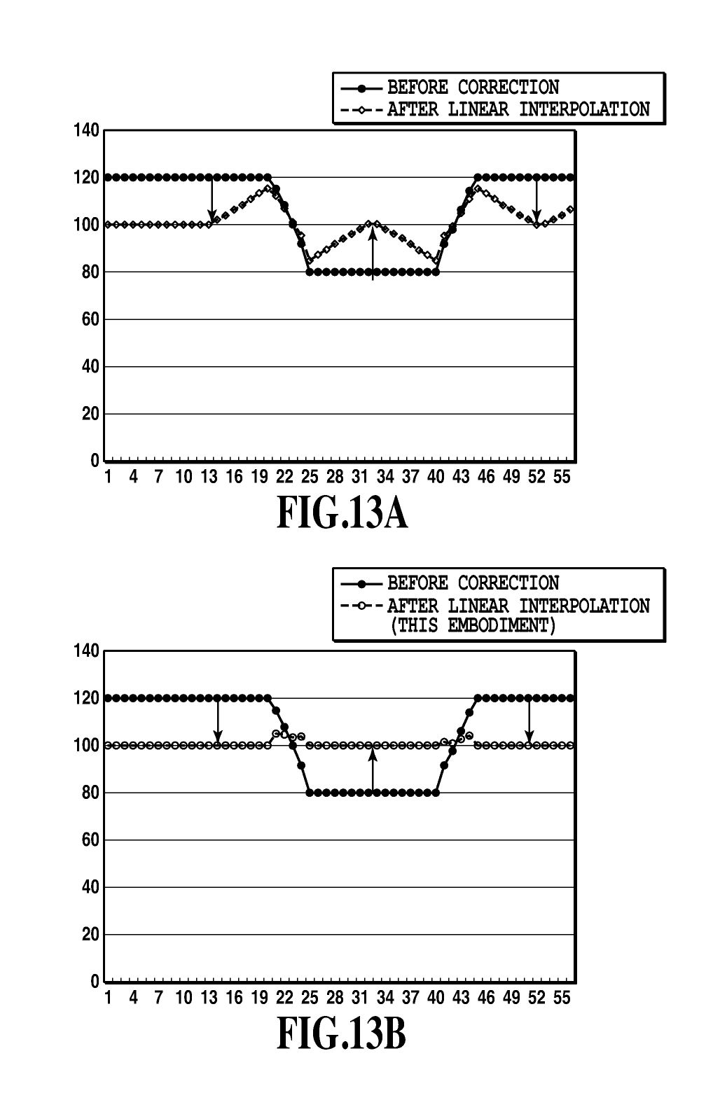

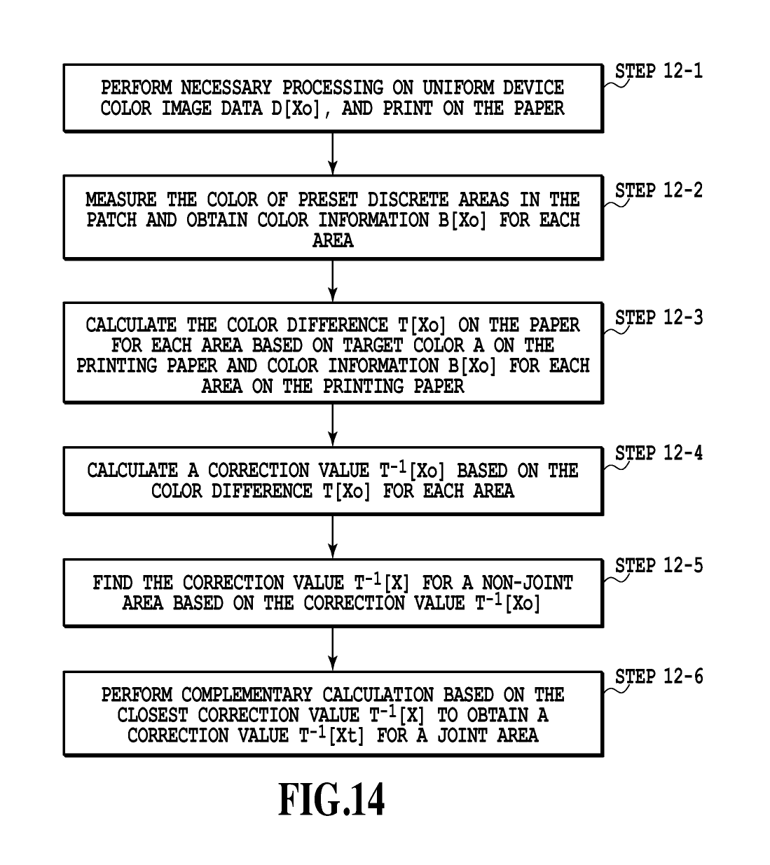

Moreover, in this embodiment, the print head illustrated in FIG. 12 is explained as having the ejection characteristics below. In other words, the cyan print head 1400 is such that the printing density of chips 1411, 1413 is 20% greater than the standard printing density, and the printing density of chip 1412 is 20% less than the standard printing density. When an image is printed by using these chips 1411 to 1413 the printing density is illustrated in FIG. 13A and FIG. 13B. The solid line in FIG. 13A and FIG. 13B indicates the correlation between the density of an image that is printed based on image data that are all the same and the nozzles. This data illustrates image data based on data before the correction process of this embodiment is performed. In the figures, the horizontal axis is the nozzle number, where each nozzle number corresponds to a nozzle position of chip 1411 in the print head illustrated in FIG. 14. In other words, the nozzle having nozzle number 1 in FIGS. 13A and 13B corresponds to the nozzle positioned at the leftmost end in the figure of chip 1411 illustrated in FIGS. 13A and 13B. The nozzle numbers are assigned in sequence 2, 3, 4, . . . , starting from the nozzle having nozzle number 1 and going toward the right side of the figures.

Moreover, the vertical axis in FIGS. 13A and 13B is the printing density of cyan having a 50% gradation, where 100 in the figures is the printing density at the standard ejection amount. Therefore, the printing density of an image that is printed by nozzles having nozzle numbers 1 to 20 is 120. The nozzles having the nozzle numbers 1 to 20 are nozzles that are included in just the head chip 1411, and are nozzles that are located in the non-joint section that does not overlap another head chip. Moreover, nozzles having nozzle numbers 21 to 24 are nozzles that are located in the joint section between the head chips 1411 and 1412, where the density of the image printed here gradually changes (decreases) according to mask processing. The nozzles having nozzle numbers 25 to 40 are nozzles located in the non-joint section of head chip 1412, where the printing density of the image printed here is 80%. The nozzles having nozzles number 41 to 44 are nozzles located at the joint section between head chips 1412 and 1413, where the printing density of an image printed by these nozzles gradually increases by mask processing. The nozzles having nozzle numbers 45 on are nozzles located in the non-joint section of head chip 1413, where the printing density of an image printed here is 120.

As described above, when printing a multi-color solid image using a joined head having head chips with different ejection amounts, color difference (color difference or difference in coloring) in an image due to a difference in ejection amount of the chips is noticeable at the joint sections and non-joint sections of the chips. However, in this embodiment, by generating MCS process parameters as will be described below, it is possible to suppress the generation of color difference in an image even when this kind of joined head is used.

FIG. 14 is a flowchart illustrating the process of generating parameters for the MCS processing performed in this embodiment. The process of generating MCS processing parameters of this embodiment has parts that are different and that are common with the basic process of generating MCS processing parameters that is explained in FIG. 5A, so the following explanation will concentrate on the differences of the two processes.

One point that is different from the basic MCS processing is that in this embodiment patch measurement locations are reduced. Here, the measurement value (color information), which is obtained by measuring the area [X] corresponding to the nozzles by using the scanner, is taken to be B[X], and the nozzles that correspond to the area having the measurement value are taken to be the color measurement nozzles (first nozzles) Xt. In the nozzle array, nozzles other than the first nozzles correspond to the second nozzles of the present invention.

In FIG. 14, the processing in step 12-1 is the same as the basic MCS processing described above, and performs the processing necessary for image data D[Xo] of the uniform device color, and prints a patch on the paper (printing medium).

In step 12-2, color measurement of the patch that is printed on the printing paper is performed. In the scanner, a large measurement aperture is formed, so in this embodiment, color measurement is performed for just the area (dots) in the patch, the area corresponding to the plurality of color measurement nozzles Xt that were set beforehand. In other words, color measurement is performed on discrete areas in the patch. More specifically, color measurement is performed on the area that corresponds to the color measurement nozzles Xt, which are X12, X32, X52, . . . . The interval between areas where this color measurement is performed is an array interval of 20 nozzles, so that the measurement value at each area is not affected by other color measurement areas. In the explanation below, an area where color measurement is performed is called a color measurement area.

In step 12-3, as in the basic MCS processing described above, the color difference (color deviation quantity) T[Xo] that corresponds to each color measurement area on the printing paper is calculated based on the target color A that is to be formed on the printing paper and the measurement value (color information) B[X] of each color measurement area on the printing paper.

In step 12-4, also as in the basic MCS processing described above, the correction value T⁻¹[Xo] is calculated based on the color difference T[Xo] of each color measurement area. In FIG. 13, the calculated correction value T⁻¹[Xo] corresponds to the position of the nozzle numbers and indicated by the arrows. The starting point of the arrows is the density before correction. As illustrated in the figure, it can be seen that the density of the image that is printed based on the image data corrected by the calculated correction value T⁻¹[Xo] is adjusted to the target density, which is the density of 100 for the standard ejection amount.

In step 12-5, the correction value T⁻¹[X] for the area (non-joint area) that is printed by nozzles located in non-joint sections of the print head is set based on the correction value T⁻¹[Xo] of the color measurement area. The method for setting this correction value T⁻¹[X] is a process of replacing the correction value of the area X closest to the color measurement area X.

The non-joint sections are the portions that correspond to nozzle numbers 1 to 20 in head chip 1411, nozzle numbers 25 to 40 in head chip 1912 and nozzle numbers 45 to 56 in head chip 1413. For the non-joint area [1] to [20] that is printed by nozzles 1 to 20 located in the non-joint section, the closest color measurement area is area [12] that is printed by nozzle X12. Accordingly, the correction value T⁻¹[12] is set as the correction value (first correction value) for the non-joint area [1] to [20]. Similarly, correction value T⁻¹[32] of area [32] is set as the correction value (first correction value) for non-joint area [25] to [40], and correction value T⁻¹[52] of area [52] is set as the correction value (first correction value) for non-joint area [45] to [56].

In the case, where there is a plurality of color measurement areas inside a non-joint area of the same head chip, the correction values of areas other than the color measurement areas in the non-joint area can be calculated by performing a complementary calculation based on a plurality of correction values that were calculated by the color measurement values of these color measurement areas.

In step 12-6, the correction values (second correction value) for the joint areas that are printed by the joint sections of the print head are calculated. This step calculates the correction value T⁻¹[X] of areas X other than the color measurement area by linear interpolation based on the correction value T⁻¹[Xo] of the color measurement areas closest to both ends of the joint area that is printed by nozzles located in the joint section. In other words, calculates the correction value of the area corresponding to the nozzles (second nozzles) other than first nozzles. For example, the correction value for the joint areas [21] to [24] that correspond to the nozzles having nozzle numbers 21 to 24 that are located in the joint sections of head chips 1411 and 1412 is calculated by linear interpolation based on the correction values for the closest areas [20] and [25] to that joint area. The correction values for the closest areas [20] and [25] have already been calculated in step 12-5, so linear interpolation is performed for the joint area using these correction values. Similarly, the correction value for areas [41] to [99] that correspond to the nozzles having nozzle numbers 91 to 44, which are the joint areas of head chip 1412 and head chip 1413 is calculated by linear interpolation based on the correction values for areas [40] and [45] that are closest to the joint areas.

Furthermore, it is known that the density of image printed by this joint section tends to increase a little more than the density corresponding to the sum of ink ejection amounts of each of the two chips. Therefore, it is necessary to measure in advance the amount of this small shift. In this embodiment, there is a tendency for the printing density in joint sections to be about 10% higher than in non-joint sections. This is considered to be due to assembly error of the head chips, or a small time difference in when the ejected ink lands on the printing medium.

Therefore, when the correction value calculated for a non-joint area is a positive value (correction is in the direction of increasing density), the correction value corresponding to the joint areas is multiplied by 0.9, and when the correction value is negative (correction is in the direction of decreasing density), the correction value is multiplied by 1.1. By doing so, it is possible to obtain a more suitable correction value. By performing the processing described above, it is possible to calculate suitable correction values (parameters) for MCS processing.

Here, the results from performing MCS processing are given in FIGS. 13A and 13B.

FIG. 13A is a comparative example to this embodiment, where a correction value for each area [X] is calculated by linear interpolation from measurement values B[X] of closest color measurement areas, and illustrates the correction results (illustrated by the dashed line in the figure) when MCS processing is performed using that correction value. The points indicated by the arrows are density of areas where correction is performed by the color measurement area, and the other points are density that is approximated by linear interpolation from the nearest areas Xt. Moreover, in the figure, the solid line indicates density before correction. As illustrated in FIG. 13A, in this comparative example, it can be seen that there are uncorrected areas that remain after correction has been performed, and the density characteristic is not sufficiently flat.

On the other hand, FIG. 13B illustrates the correction results (dashed line in the figure) when MCS processing is performed based on correction results calculated by using this embodiment. As illustrated in FIG. 13B, it can be seen that regardless of whether or not the area is a non-joint area, a flat density characteristic is obtained and thus good correction results are obtained. Even in the case of using a colorimeter having a large color measurement aperture, or a print head having narrow joint areas with respect to the measurement aperture, by calculating the correction values using different complementary processing as described above for joint sections and non-joint sections, good color correction results are obtained.

In this embodiment, when calculating the correction value for the second nozzles, only the nozzles closest to the second nozzles are used; however, a plurality of nozzles that are adjacent to the second nozzles can also be used. For example, in this embodiment, the correction value for [41] to [44] is calculated by linear interpolation based on correction values for [40] and [45], however, correction values for [38] to [40] and [45] to [47] can also be used.

Moreover, in this embodiment, an example was explained wherein each area division in the nozzle array direction (x direction) is one nozzle. However, it is also possible for a plurality of nozzles to correspond to each area, or in other words a nozzle group comprising one or more nozzles only corresponds to one area. In this case, in the explanation above, the first nozzle corresponds to the first nozzle group, and the second nozzle corresponds to the second nozzle group.

Furthermore, in this embodiment, the correction value for second nozzles that are located in the non-joint section is set by complementary processing that substitutes the correction value for the first nozzle closest to the second nozzles. However, it is also possible to use complementary processing that is different from this, and as a result obtain a different correction value. When doing that, the correction value for a second nozzle that is located in a joint section can be calculated by complementary calculation based on the correction values of the second nozzles in the non-joint section that are closest to the second nozzle, or could be calculated by complementary calculation based on the correction values of first nozzles in the non-joint section that are closest to the second nozzle in the joint section.

### Other Embodiments

In the embodiment above, an example was explained for the case wherein correction values to be used in MCS processing were calculated based on the color measurement values obtained by measuring the color of a multi-color patch; however, the present invention can also be applied to the case wherein correction values to be used in HS processing are calculated by measuring the color of a single-color patch. In other words, the present invention can be applied not only to processing such as MCS processing that eliminates color unevenness as a color difference occurring in an image, but can also be applied to processing such as HS processing that eliminates density unevenness as color difference occurring in an image. When applying the present invention to HS processing, in the flowchart illustrated in FIG. 14, the color information can be changed to density information, and the target color can be changed to target density, and processing can be performed the same as in steps 12-1 to 12-6.

In addition, in the embodiment described above, an example was explained where the joint sections of the head chips in the print head where narrower than the measurement aperture, however, as long as the joint section is within a range in which color measurement can be performed using the measurement aperture, it is possible to make the joint sections wider than in the embodiment above. In this case as well, as in the first embodiment above, by calculating correction values for joint sections and non-joint sections that have different printing characteristics by using two kinds of complementary processing, it is possible to obtain good color correction results in MCS process.

Moreover, the present invention is not limited to the embodiments above, and it is possible to use processing such as weighted average processing or convolution operation as the process for setting a correction value in non-joint areas.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-225751, filed Oct. 5, 2010, which is hereby incorporated by reference herein in its entirety.

What is claimed is:

1. An inkjet printing apparatus that prints an image on a printing medium by using a print head, wherein a plurality of nozzle arrays that eject ink of the same color are arranged such that there are joint sections in a direction that differs from the direction that the nozzles are arranged in the nozzle array, and ejecting ink from the nozzles according to input image data, the inkjet printing apparatus comprising:
a correction value calculation unit configured to calculate correction values for each nozzle group obtained by dividing up the plurality of nozzles of the print heads in order to correct input image data by reducing color differences among the images printed by the different nozzle groups; wherein
the correction value correction unit comprises:
a first calculation unit configured to calculate a first correction values as the correction value, the first correction value being used for correcting input image data corresponding to a first nozzle group that prints a patch, based on the color measurement value obtained by measuring a color of a patch printed by first nozzle group that is located at discrete positions among the nozzle groups; and
a second calculation unit configured to calculate a second correction value as the correction value, the second correction value being used for correcting the input image data corresponding to a second nozzle group of the plurality of nozzle groups different from the first nozzle group by performing a complementary process based on the first correction value; wherein
the second calculation unit performs a different complementary process for a second nozzle group that is located in the joint section and a second nozzle group that is located in a non-joint section that is different from the joint section.

2. The inkjet printing apparatus according to claim 1, further comprising the plurality of print heads that eject ink having different colors, wherein
the patch is printed in multi colors by the plurality of print heads, and
the correction calculation unit calculates a correction value for reducing color difference in an image that is printed in multi colors.

3. The inkjet printing apparatus according to claim 1, wherein the print head prints the patch in a single color.

4. The inkjet printing apparatus according to claim 1, wherein the second calculation unit calculates the second calculation value for the second nozzle group that is located in the non-joint section based on the first correction value for the first nozzle group that is the closest to the second nozzle group.

5. The inkjet printing apparatus according to claim 1, wherein the second calculation unit calculates the second correction value for the second nozzle group that is located in a joint section based on the first correction values for the first nozzle groups in two non-joint sections that are adjacent to that joint section respectively.

6. The inkjet printing apparatus according to claim 1, wherein the second calculation unit calculates the second correction value for the second nozzle group that is located in a joint section based on the first correction values for the first nozzle groups in two non-joint sections that are adjacent to that joint section respectively.

7. The inkjet printing apparatus according to claim 1, further comprising a color measurement unit configured to measure color of a patch that is printed by the first nozzle group.

8. The inkjet printing apparatus according to claim 1, wherein the second calculation unit calculates the second correction value for the second nozzle group located in a joint section by linear interpolation.

9. An inkjet printing method that prints an image on a printing medium by using a print head, wherein a plurality of nozzle arrays that eject ink of the same color are arranged such that there are joint sections in a direction that differs from the direction that the nozzles are arranged in the nozzle array, and ejecting ink from the nozzles according to input image data, comprising:
a correction value calculation step of calculating correction values for each nozzle group obtained by dividing up the plurality of nozzles of the print heads in order to correct input image data by reducing color differences among the images printed by the different nozzle groups; wherein
the correction value calculation step comprises:
a first correction value calculation step of calculating a first correction values as the correction value, the first correction value being used for correcting input image data corresponding to a first nozzle group that prints a patch, based on the color measurement value obtained by measuring a color of a patch printed by first nozzle group that is located at discrete positions among the nozzle groups; and
a second calculation step of calculating a second correction value as the correction value, the second correction value being used for correcting the input image data corresponding to a second nozzle group of the plurality of nozzle groups different from the first nozzle group by performing a complementary process based on the first correction value; wherein
the second calculation step performs a different complementary process for a second nozzle group that is located in the joint section and a second nozzle group that is located in a non-joint section that is different from the joint section.

10. The inkjet printing method according to claim 9, wherein a plurality of print heads is used for ejecting ink having different colors,
the patch is printed in multi colors by the plurality of print heads, and
the correction calculation step calculates a correction value for reducing color difference in an image printed in multi colors.

11. An image processor that processing input image data for printing an image a on a printing medium by using a print head, wherein a plurality of nozzle arrays that eject ink of the same color are arranged such that there are joint sections in a direction that differs from the direction that the nozzles are arranged in the nozzle array, and ejecting ink from the nozzles according to input image data, the inkjet printing apparatus comprising:
a correction value calculation unit configured to calculate correction values for each nozzle group obtained by dividing up the plurality of nozzles of the print heads in order to correct input image data by reducing color differences among the images printed by the different nozzle groups; wherein
the correction value correction unit comprises:
a first correction value calculation unit configured to calculate a first correction values as the correction value, the first correction value being used for correcting input image data corresponding to a first nozzle group that prints a patch, based on the color measurement value obtained by measuring a color of a patch printed by first nozzle group that is located at discrete positions among the nozzle groups; and
a second calculation unit configured to calculate a second correction value as the correction value, the second correction value being used for correcting the input image data corresponding to a second nozzle group of the plurality of nozzle groups different from the first nozzle group by performing a complementary process based on the first correction value; wherein
the second calculation unit performs a different complementary process for a second nozzle group that is located in the joint section and a second nozzle group that is located in a non-joint section that is different from the joint section.

12. The image processor according to claim 11, wherein
the input image data is data for printing an image using a plurality of print heads that eject ink having different colors,
the patch is printed in multi colors by the plurality of print heads, and
the correction calculation unit calculates a correction value for reducing color difference in an image that is printed in multi colors.

13. An image processing method of processing input image data for printing an image a on a printing medium by using a print head, wherein a plurality of nozzle arrays that eject ink of the same color are arranged such that there are joint sections in a direction that differs from the direction that the nozzles are arranged in the nozzle array, and ejecting ink from the nozzles according to input image data, comprising:
a correction value calculation step of calculating correction values for each nozzle group obtained by dividing up the plurality of nozzles of the print heads in order to correct input image data by reducing color differences among the images printed by the different nozzle groups; wherein
the correction value correction unit comprises:
a first correction value calculation step configured to calculate a first correction values as the correction value, the first correction value being used for correcting input image data corresponding to a first nozzle group that prints a patch, based on the color measurement value obtained by measuring a color of a patch printed by first nozzle group that is located at discrete positions among the nozzle groups; and
a second calculation step configured to calculate a second correction value as the correction value, the second correction value being used for correcting the input image data corresponding to a second nozzle group of the plurality of nozzle groups different from the first nozzle group by performing a complementary process based on the first correction value; wherein
the second calculation step performs a different complementary process for a second nozzle group that is located in the joint section and a second nozzle group that is located in a non-joint section that is different from the joint section.

14. The image processing method according to claim 13, wherein
the input image data is data for printing an image using a plurality of print heads that eject ink having different colors,
the patch is printed in multi colors by the plurality of print heads, and
the correction calculation unit calculates a correction value in order to reduce color difference in an image that is printed in multi colors.
